(19) United States
(12) Patent Application Publication
(10) Pub. No.: US 2010/0275150 A1
(43) Pub. Date: Oct. 28, 2010

(54) TERMINAL DEVICE, LINK SELECTION METHOD, AND DISPLAY PROGRAM

(75) Inventors: Ohki Chiba, Tokyo (JP); Koji Matsuzawa, Kanagawa (JP)

Correspondence Address: MORRISON & FOERSTER LLP, 425 MARKET STREET, SAN FRANCISCO, CA, 94105-2482, US

(73) Assignee: ACCESS CO., LTD., Tokyo (JP)

(21) Appl. No.: 12/681,102

(22) PCT Filed: Oct. 1, 2008
(86) PCT No.: PCT/JP2008/067826

§ 371 Date: Mar. 31, 2010

(30) Foreign Application Priority Data
Oct. 2, 2007 (JP) 2007-259273
Oct. 30, 2007 (JP) 2007-281723

(51) Int. Cl. G06F 3/041; G06F 3/048

(52) U.S. Cl. 715/784; 345/173; 715/800; 715/788; 715/810

(57) ABSTRACT

In a terminal apparatus for displaying as an image, a document in which a link is set, on a display screen which also serves as a touch panel, a favorable operation is achieved including link selecting operation, or the like, while eliminating a conflict in a touch operation. To this end, when a touch is made on a browser screen by a finger 350 of a user, a link selection is allowed only within a link effective field 360 including a position being touched. Then, when the touch is released within the link effective field 360 transition is made to a destination of the link being in the touched state. When the touch is moved outwardly from inside the link effective field 360 while keeping the touched state of the touch, a predetermined process other than the link selection is performed based on at least one of a relative direction or a moved distance of the touch with respect to the initial position of the touch. When a second touch is made while the touched state of the first touch is maintained, the predetermined process is disabled, and a link designation is accepted all over the display screen of the document data.

### TECHNICAL FIELD

The present invention relates to a terminal apparatus having a display screen which also serves as a touch panel, and displaying thereon a document in the form of an image, the document being provided with a link set therein.

### BACKGROUND ART

Conventionally, in many cases, a user utilizes a pointing device such as a mouse, as a controller for providing instructions to a PC device or the like. In the case of a laptop PC, a touch pad is usually prepared as the pointing device. On a display screen of a browser, which is an application for displaying a Web page being a document written in a markup language such as HTML, the pointing device manipulates a cursor such as an arrow mark, to conduct a link selecting operation for selecting a character or a graphic symbol which is associated with a portion provided with a link set in the Web page. With the cursor placed on a target portion where the link is placed, a predetermined operation referred to as “click” is performed will cause transition to a destination of the link.

In the case where the size of a Web page is large and apart of the page extends off the display screen, a scroll operation is input to move the display image in order to view the hidden part. For this scroll operation, there is displayed a control element, referred to as “scroll bar”, on the edge of the display screen. Operation by the pointing device on the scroll bar enables scrolling. Typically, a scroll bar extending vertically on the right edge of the display screen is used for scrolling in the vertical direction, and a scroll bar extending horizontally on the lower edge of the display screen is used for scrolling in the horizontal direction.

Patent document 1 discloses a technique which enables scrolling simultaneously in the both directions, vertically and horizontally. This technique is directed to a data processing system using a display screen, in which an object being movable two-dimensionally by a pointer and serving as an icon dedicated to scrolling is displayed at a home position of the window. Then, the technique allows the object to move according to dragging by the pointer, thereby scrolling data in the moving direction of the object, and in addition, the object is allowed to return to the home position when it is released, simultaneously stopping the scroll of the data.

Patent document 2 discloses a technique that a scrolling speed or a scrolling amount is determined based on a distance between a reference point and a cursor, and a scrolling direction is determined according to a straight line which connects the cursor and the reference point.

In addition, a touch panel is used as a pointing device, which is superimposed on a display screen, and an instruction is provided by touching the panel by a finger. For this case, there is disclosed a technique for modifying a display mode of display contents, according to the number of times of touch by the finger. Specifically, it discloses the following points: a map screen is scrolled in the direction touched by the finger with reference to the center position of the map screen; while keeping this state, the touch panel is touched by the second finger and scrolling speed is doubled; and while touching the touch panel by the two fingers, the second touching finger is moved upwardly or downwardly, thereby changing the scale of the map.

Patent document 1

### Japanese Unexamined Patent Application Publication No. 7-21006

Patent document 2

### Japanese Unexamined Patent Application Publication No. 1-179193

Patent document 3

### Japanese Unexamined Patent Application Publication No. 2005-234291

### DISCLOSURE OF THE INVENTION

### Problem to be solved by the Invention

In recent years, as an advance on a mobile phone terminal, a portable terminal apparatus, such as so-called “smart phone”, now appears on the market, and such portable terminal apparatus is made multifunctional, with a display screen larger than the mobile phone terminal. In order that the display screen is rendered to be large as possible, while keeping its housing size small, some portable devices employ only a few manual operation buttons as hardware operating unit, eliminating a hardware keyboard. Another type of device is also known in which the hardware keyboard is provided, being configured in such a manner that the keyboard is usually hidden behind the display device and it is made to slide out, only when needed. Even in the latter case, the outside dimension of the device becomes large in the state where the keyboard is slide-out, and portability may be impaired. Furthermore, this may increase the production cost. Accordingly, it is preferable that a user interface does not require any keyboard for use.

From the viewpoint as described above, another type of device as disclosed by the patent document 3 appears, having a display screen also serving as a touch panel, which is not provided with a hardware keyboard and utilizes a wide display screen as an operating unit.

However, in the case where a link is selected, unlike the device using a pointing device such as a mouse, it is not possible to perform two-stage operations, i.e., moving a cursor and clicking, on a device of the type having the display screen also serving as the touch panel. In other words, a touch on a portion where the link is placed on the display screen of a browser immediately causes transition to the link destination. This quick operation is preferable from the viewpoint for selecting the link, but if the link selection is made erroneously, a moving action is performed to a link destination against the user's will, and therefore, there is a defect that the operation is made more cumbersome and complicated.

In particular, even though a portable terminal such as the smart phone has a display screen larger in size than that of a conventional mobile phone terminal, it is incomparably smaller than the display screen of a PC. Despite this, the portable terminal is capable of displaying a page of Web site for PC use. Therefore, a scroll operation is indispensable for viewing an image which extends off screen, and its operability is extremely important. Therefore, when the touch panel is used both for the link selecting operation and for the scroll operation, there occurs a conflict between both operations, if it is tried to employ an intuitive scroll operation without using a scroll bar.

The touch panel is further available for an operation other than the link selection and the scroll operation, and this may also cause a conflict in the operation.

The present invention has been made in the background as described above, and an object of the invention is directed to a terminal apparatus for displaying a document as an image where a link is placed, on the display screen which also serves as a touch panel, which achieves a favorable link selecting operation, or the like, while eliminating a conflict in the touch operation.

### Means to Solve the Problem

A terminal apparatus according to the present invention includes a touch panel for detecting coordinates of a touch position, a display unit where a touch field of the touch panel overlaps with at least a part of a display field thereof, a storage unit for storing document in which a link is set, and a controller. This controller serves to interpret the document data and generate display information to be displayed on the display unit, to set a predetermined range including a position being touched, as a link effective field, to allow a selection of the link only within the link effective field, to make transition to a link destination of the link having been in a touched state at the time of releasing of the touch within the link effective field, and to perform a predetermined process other than the link selection, when the touch moves outwardly from inside the link effective field while keeping the touched state. The processing other than the link selection may be performed, for example, according to at least one of a relative moving direction and a distance of the touch with respect to the position being touched.

As described above, in the present invention, a predetermined range including the touch position is set as the link effective field, and a link is allowed to be selected only within the link effective field. When the touch moves outwardly from inside the link effective field, while keeping the touched state, the link selection is disabled outside the field. Typically, in selecting a link, it may be considered that there are not significant displacements even when the touch position is deviated from the target link, and therefore, it is not a problem to restrict the link effective field to a predetermined range. By restricting the link effective field to the predetermined range, it is possible to smoothly move from the touch operation for selecting a link, to another touch operation for performing a predetermined process other than the link selection.

Preferably, when a touch is made on the touch panel, the controller controls the display unit to display the link effective field in such a manner as identifiable by a user. Such display may give a guideline for the user to conduct an operation.

When a touch is made on the touch panel, the controller may allow the display unit to temporarily enlarge a display image of the document data under a predetermined condition. Alternatively, the controller may allow the display unit to enlarge and display the link effective field under a predetermined condition. The procedure as described above may facilitate a touch operation using a finger.

The predetermined condition may be decided according to the number of links belonging to the link effective field or an area of the touch. For example, the enlargement is performed when the number of links or the area of the touch is equal to or larger than a predetermined value.

The controller may serve to display link information of the link being touched within the link effective field, at a position other than the position being touched. With this configuration, even though the link is hidden by the touch, the contents of the link can be easily confirmed.

The controller may disable the link effective field, if no links exist within the link effective field when a touch is made on the touch panel. This configuration may immediately enable a touch operation for performing a predetermined process other than the link selection, without the necessity of displaying the link effective field.

For example, the predetermined process other than the link selection may be a process for changing a display mode of the document data. More specifically, it is a process for scrolling the display image of the document data.

One example of the scrolling process is to perform scrolling toward the initially touched position (referred to as “initial position”), with respect to a position of the destination to which the touch has moved.

Another example of the scrolling process is to continue scrolling at a scrolling speed in accordance with a distance from the initial position to the position of the destination, until the touch is released. Preferably, in this case, when the touch moves outwardly from inside the link effective field, while keeping the touch, the controller serves to erase the link effective field and display a predetermined mark at the initial position. According to the space between this predetermined mark and the touch position, a user is allowed to estimate the “distance” and the scrolling direction.

Further alternative example of the scrolling process is to perform scrolling in sync with movement of the touch from the initially touched position to the position of the destination to which the touch has moved.

For example, the predetermined process other than the link selection is a process for displaying menu items and selecting one from the menu items which are associated with displaying the document data.

A link selection method according to the present invention is to select a link in a terminal apparatus for displaying as an image a document to which a link is placed, on a display screen which also serves as a touch panel, and the link selection method including the steps of: interpreting the document data and generating display information which is displayed on the display screen, setting a predetermined range including a position being touched as a link effective field, allowing a link selection only within the link effective field, making transition to a destination of the link which has been in the touched state when the touch is released in the link effective field, and executing a predetermined process other than the link selection when the touch moves outwardly from inside the link effective field, while the touch keeps the touched state.

It is also possible to consider that the present invention further includes an aspect of a display program which is executed in the controller of the terminal apparatus for displaying as an image a document provided with a link, on a display screen which also serves as a touch panel.

The terminal apparatus according to the present invention is provided with a touch panel for detecting coordinates of a position being touched, a display unit where a touch field of the touch panel overlap one another within at least apart of the display field, a storage unit for storing document data to which a link is placed, and a controller, wherein, the controller serves to interpret the document data and generate display information to be displayed on the display unit, to make transition to a destination of the link which has been in the touched state when the touch is released in the link selecting process, to perform a predetermined process based on a first touch, and to disable the predetermined process when a second touch is made while keeping the touched state of the first touch, and activating the link selecting process based on at least one of the first touch and the second touch, all over the display screen of the document data.

In the configuration above, processing is switched according to the number of touches in the touched state on the touch panel, which are simultaneously maintained at a certain point of time. In other words, when only the first touch is made, the “predetermined process” is performed, and when the second touch is made in the state where the first touch is maintained, the “predetermined process” is disabled, and the link selecting process based on at least one of the first touch and the second touch is activated all over the display screen of the document data. Accordingly, it is possible to prevent a conflict between the “link selection” and the “predetermined process”, which are performed by the touch operation.

For example, the predetermined process is a scrolling process for scrolling the display image of the document data according to movement of the first touch. Alternatively, it is a process for allowing a selection of link only within the link effective field which defines a predetermined range including a position being touched by the first touch.

As a more specific embodiment, for example, the controller performs the scrolling process based on the first touch and disables the scrolling process based on the second touch, and at the same time, allowing the link selecting process to be performed based on the first touch whose touched state is maintained.

According to another embodiment, the controller performs the scrolling process based on the first touch and disables the scrolling process based on the second touch, and at the same time, allowing the link selecting process to be performed based on the second touch.

Preferably, in the case where the link selecting process is activated, the controller is further serves to display link information of the link at a location other than the touch position, when at least one of the first touch and the second touch designates a portion where the link is placed.

A link selection method according to the present invention for selecting a link on the terminal apparatus which displays as an image a document on which a link is placed, on the display screen also serving as a touch panel, includes the steps of: interpreting the document data and generating display information to be displayed on the display screen, moving to a destination of the link which has been in a touched state when the touch is released in a link selecting process, executing a predetermined process based on a first touch, and disabling the predetermined process when a second touch is made in the state that the touched state of the first touch is maintained, and activating the link selecting process based on at least one of the first touch and the second touch all over the display screen of the document data.

A display program according to the present invention is a program executed in the controller of the terminal apparatus for displaying as an image a document on which a link is placed, on a display screen also serving as a touch panel, and the display program allows a computer to perform the steps including the steps of: interpreting document data and generating display information to be displayed on the display screen, moving to a destination of the link which has been in a touched state when the touch is released in a link selecting process, executing a predetermined process based on a first touch, and disabling the predetermined process when a second touch is made while the touched state of the first touch is maintained, and activating the link selecting process based on at least one of the first touch and the second touch all over the display screen of the document data.

Other configurations, operations and effects of the present invention will be explained below in detail.

### EFFECT OF THE INVENTION

According to the present invention, in the terminal apparatus for displaying as an image a document on which a link is placed, on the display screen also serving as a touch panel, it is allowed to select a link only within the link effective field which defines a predetermined range including a position being touched, and a predetermined process other than the link selection is performed when the touch moves outwardly from inside the link effective field, while the touch is maintained to be in the touched state. Therefore, it is possible to resolve a conflict in the touch operation, and achieve operations including a preferable link selection or the like with the minimum number of touch operation times. Therefore, operability of the terminal apparatus can be drastically improved.

In addition, it is not necessary to display a conventional scroll bar, thereby allowing an effective use of the display screen.

Further, according to another aspect of the present invention, in the terminal apparatus for displaying as an image a document on which a link is placed, on the display screen also serving as a touch panel, processing is switched according to whether or not the second touch is made in response to the first touch, thereby eliminating a conflict in the touch operation and achieving operations including a preferable link selection and the like.

### BRIEF DESCRIPTION OF THE DRAWINGS

FIG. 1 is a block diagram showing a schematic configuration of a portable terminal as one example of the terminal apparatus relating to an embodiment of the present invention;

FIG. 2 is a block diagram showing a schematic internal configuration of the portable terminal as shown in FIG. 1;

FIG. 3 is a functional block diagram showing key functions of the portable terminal as shown in FIG. 2;

FIG. 4 illustrates a display screen example of a display device in the portable terminal as shown in FIG. 1;

FIG. 5 illustrates a major operation example according to an embodiment of the present invention;

FIG. 6 illustrates a screen example of a destination of the link, subsequent to the operation as shown in FIG. 5;

FIG. 7 illustrates scrolling of a Web page according to an embodiment of the present invention;

FIG. 8 illustrates a screen showing a scrolling halt subsequent to the operation as shown in FIG. 7;

FIG. 9 illustrates an example of a second scroll operation of a Web page according to an embodiment of the present invention;

FIG. 10 illustrates a modification example for the sake of convenience in selecting a link according to an embodiment of the present invention;

FIG. 11 illustrates a modification example relating to whether the link effective field is set or not according to an embodiment of the present invention;

FIG. 12 illustrates a processing for displaying and selecting a menu item relating to the display of the document data according to an embodiment of the present invention;

FIG. 13 is a flowchart of a basic processing according to an embodiment present invention;

FIG. 14 includes flowcharts showing the link effective field relating processing (1) and (2), corresponding to step S13 shown in FIG. 13;

FIG. 15 includes flowcharts showing the link effective field relating processing (3) and (4), corresponding to step S13 shown in FIG. 13;

FIG. 16 is a flowchart showing a detailed processing example of step S15 shown in FIG. 13;

FIG. 17 is a flowchart showing a scrolling process (1) as a processing example of step S16 shown in FIG. 13;

FIG. 18 is a flowchart showing a scrolling process (2) as a processing example of step S16 shown in FIG. 13;

FIG. 19 is a flowchart showing a menu selecting process as a processing example of step S16 shown in FIG. 13;

FIG. 20 is a functional block diagram showing key functions of the portable terminal according to a second embodiment of the present invention;

FIG. 21 illustrates a screen example for explaining major operations according to the second embodiment of the present invention;

FIG. 22 illustrates a screen example for explaining the major operations according to the second embodiment of the present invention;

FIG. 23 illustrates a screen example for explaining the major operations according to the second embodiment of the present invention;

FIG. 24 illustrates a screen example for explaining the major operations according to the second embodiment of the present invention;

FIG. 25 is a flowchart representing a first operation example according to the second embodiment of the present invention;

FIG. 26 is a flowchart representing a second operation example according to the second embodiment of the present invention;

FIG. 27 is a flowchart representing a third operation example according to the second embodiment of the present invention;

FIG. 28 is a functional block diagram showing key functions according to a third embodiment of the present invention;

FIG. 29 is a flowchart showing an example of processing procedure of the first operation example according to the third embodiment of the present invention;

FIG. 30 is a flowchart showing an example of processing procedure of the second operation example according to the third embodiment of the present invention; and

FIG. 31 is a flowchart representing a third operation example according to the third embodiment of the present invention.

### BEST MODE FOR CARRYING OUT THE INVENTION

Hereinafter, preferred embodiments of the present invention will be explained in detail with reference to the accompanying drawings.

Firstly, a configuration of the present embodiment will be explained.

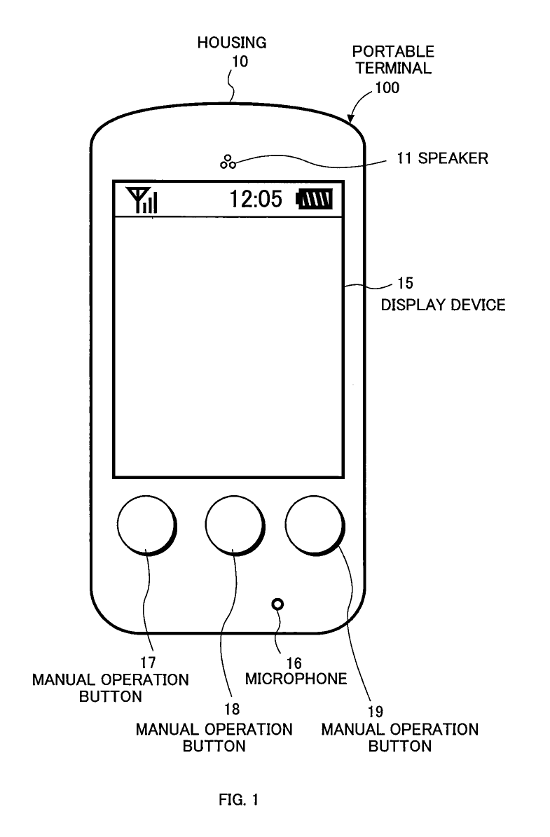

FIG. 1 is a block diagram showing a schematic configuration of a portable terminal 100 as one example of a terminal apparatus which is provided with a calling function, a data communication function, and a Web browser function for performing a process to display a markup language document. The portable terminal 100 is a multifunctional portable phone terminal, so called “smart phone”, which incorporates a speaker 11, a display device 15 provided with a touch panel function, a microphone 16, and manual operation buttons 17 to 19 within the housing 10. This portable terminal is not provided with a hardware keyboard, a ten-key pad, or the like. If a character input is necessary, a software keyboard (not illustrated) is displayed on the display screen of the display device 15, thereby allowing a touch input.

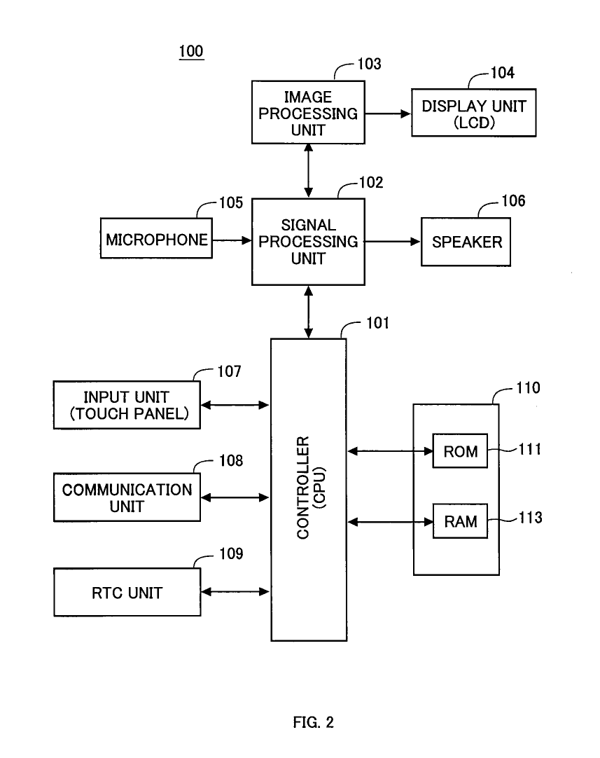

FIG. 2 is a block diagram showing a schematic internal configuration of the portable terminal 100. The portable terminal 100 is provided with a controller 101, a signal processing unit 102, an image processing unit 103, a display unit 104, a microphone 105, a speaker 106, an input unit 107, a communication unit 108, an RTC (Real Time Clock) unit 109, and a storage unit 110.

The controller 101 includes a CPU (central processing unit), and it is responsible for controlling all over the device according to a program control.

The signal processing unit 102 is a unit for performing various signal processing under the control of the controller 101, such as digitizing an audio input from the microphone 105 (indicated by the reference numeral 16 shown in FIG. 1) to pass the digitized input to the controller 101, converting audio output data (including an operation sound in the present embodiment) from the controller 101 into analog to output the converted data to the speaker 106 (indicated by the reference numeral 11 shown in FIG. 1), and performing various signal processing for sending and receiving signals to and from the image processing unit 103.

The image processing unit 103 serves to receive display data from the signal processing unit 102, and display the data on the display unit 104. A display LSI supporting a graphic processing may constitute the image processing unit 103.

The display unit 104 includes a display device 15 such as a liquid crystal display (LCD) or an organic EL, and displays to a user, information such as character, graphics, and images. Particularly in the present embodiment, the display unit 104 displays a Web page being a document which is written in a markup language such as HTML. Typically, the display information of the Web page may include character, graphics, and images, but in the present specification, those items as a whole are simply referred to as “display image” or “image”.

The input unit 107 includes a touch panel (touch input unit) in addition to the manual operation buttons 17 to 19 as shown in FIG. 1. The input unit 107 serves to receive a directive operations and data inputs from a user using a finger, and to pass the operations and inputs to the controller 101. In the present embodiment, the input range of the touch panel covers all over the surface of the display screen of the display unit 104. However, it is not necessary to cover all over the surface, and the touch panel may cover only a partial region on the display screen.

The communication unit 108 is a portion for making a phone-call and performing data communications, and it establishes communication with a base station via a wireless interface using radio wave byway of antenna (not illustrated). Connection to the Internet can be established via the communication unit 108, but other communication unit (e.g., wireless LAN communication unit), not illustrated, may also be applicable.

The RTC unit 109 serves to output date and time information, and performs a timer function.

The storage unit 110 includes ROM 111 and RAM 113. In addition, the storage unit 110 may also include other storage such as hard disk device. The ROM 111 is a nonvolatile memory for storing various programs executed by the CPU of the controller 101 and necessary data, and the ROM 111 includes a rewritable region. The RAM 113 is a memory for providing a work space for the CPU and a temporary region for storing data. The RAM 113 stores Web page data or the like, in the present embodiment.

In addition to the elements described above, though not illustrated, other elements may be provided, such as a GPS (Global Positioning System) receiver, a Bluetooth (Registered Trademark) communication unit, a wireless LAN communication unit, a camera shooting unit, and a TV receiver.

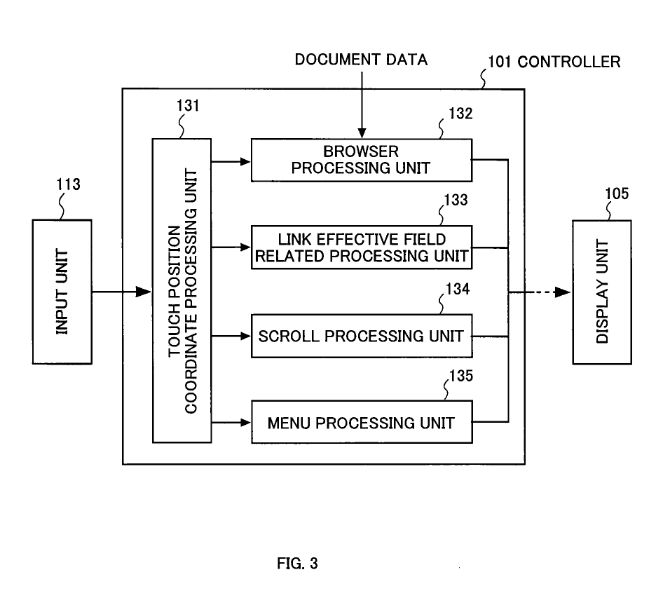

FIG. 3 is a functional block diagram illustrating key functions of the portable terminal 100 shown in FIG. 2.

There are provided functions which are implemented by the controller 101, including a touch position coordinate processing unit 131, a browser processing unit 132, a link effective field related processing unit 133, a scroll processing unit 134, and a menu processing unit 135.

The touch position coordinate processing unit 131 is a functional unit for detecting that the user touches the touch panel, as well as the coordinates of the position (touch position). Preferably, this touch position coordinate processing unit is of a type which is able to detect multiple touch positions being touched at a time, and detect a touched area of one touch position. However, these additional functions as described above are not indispensable to the key functions according to the present embodiment. The touch position coordinate processing unit 131 gives information such as touch position coordinates, which are detected in response to a touch operation against the input unit 113 by the user, to the browser processing unit 132, the link effective field related processing unit 133, the scroll processing unit 134, and the menu processing unit 135. Moreover, the touch position coordinate processing unit 131 stores in the storage unit 110 as history data, at least data of the latest touch position and data of the past variation.

The browser processing unit 132 is a functional unit for receiving from the storage unit 110, the document data written in a markup language, analyzing the data, and generating the display data to be displayed on the screen, and it further serves to check a portion where a link is placed, in the form of a predetermined tag (e.g., anchor tag), and a function for making transition to a destination of the link, based on the touch on the portion where the link is placed.

The link effective field related processing unit 133 is a portion for performing processing relating to the link effective field, such as setting, displaying, and erasing the link effective field, under a predetermined condition, in response to an output from the touch position coordinate processing unit 131. This includes processes for setting, displaying, and erasing an initial position (mark) which will be described below, and further includes processes for displaying and erasing a link information display field which will be described below.

The scroll processing unit 134 performs processing for moving (i.e., scrolling) an overall display image within the browser screen under a predetermined condition, in response to an output from the touch position coordinate processing unit 131.

As an additional feature of the present embodiment, the menu processing unit 135 is a portion for displaying multiple menu items in combination with the link effective field, and performing a process for allowing a user to select an item from the menu.

Hereinafter, with reference to specific display screens, examples of major operations, additional operations, and modifications of the present embodiment will be explained one by one.

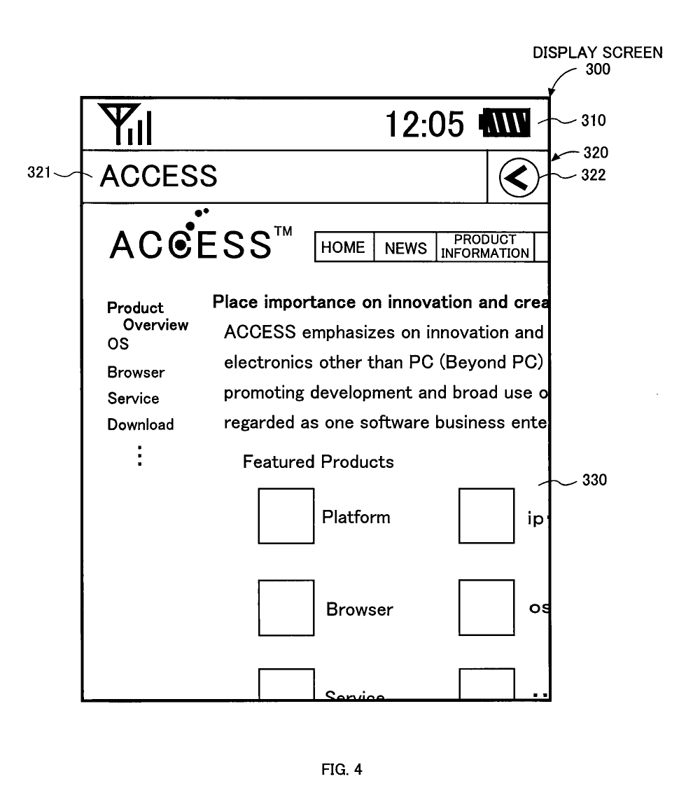

FIG. 4 illustrates a display example of the display screen 300 of the display device 15 in the portable terminal 100 shown in FIG. 1. In the display screen 300, horizontally long band-like region 310 on the upper edge is an area for displaying a radio wave receiving strength, time, remaining battery power, and the like, of the portable phone. The horizontally long band-like region 320 below and the main field 330 further below indicate a browser screen. At least all over the browser screen serves as a touch panel field.

The region 320 includes a title display field 321 for displaying a title of the Web page being currently displayed in the main field 330, and an operation region 322. In this particular example, when a position of the operation region 322 is touched, the operation region 322 is expanded within the region 320, and other operation-use buttons (not illustrated) are displayed therein.

The main field 330 shows an example of a large-sized Web page (upper-left part) partially off screen, which is obtained by accessing a Web site typically designed for PC use, for instance. In the figure, it is assumed that a link is placed on each of the character strings on the left side of the Web page, “Product Overview”, “OS”, “Browser”, “Service”, and “Download”, and also on each of the character strings positioned from the center to the lower right, “Platform”, “Browser”, “Service”, and “ip . . . ” It is further possible to provide a link on each of the graphics represented by square marks in the figure. When an effective touch is made on the position of the character or the graphics, each provided with a link, transition is made to a destination of the link of the portion where the link is placed, and a Web page of the link destination is displayed, substituting for the current Web page.

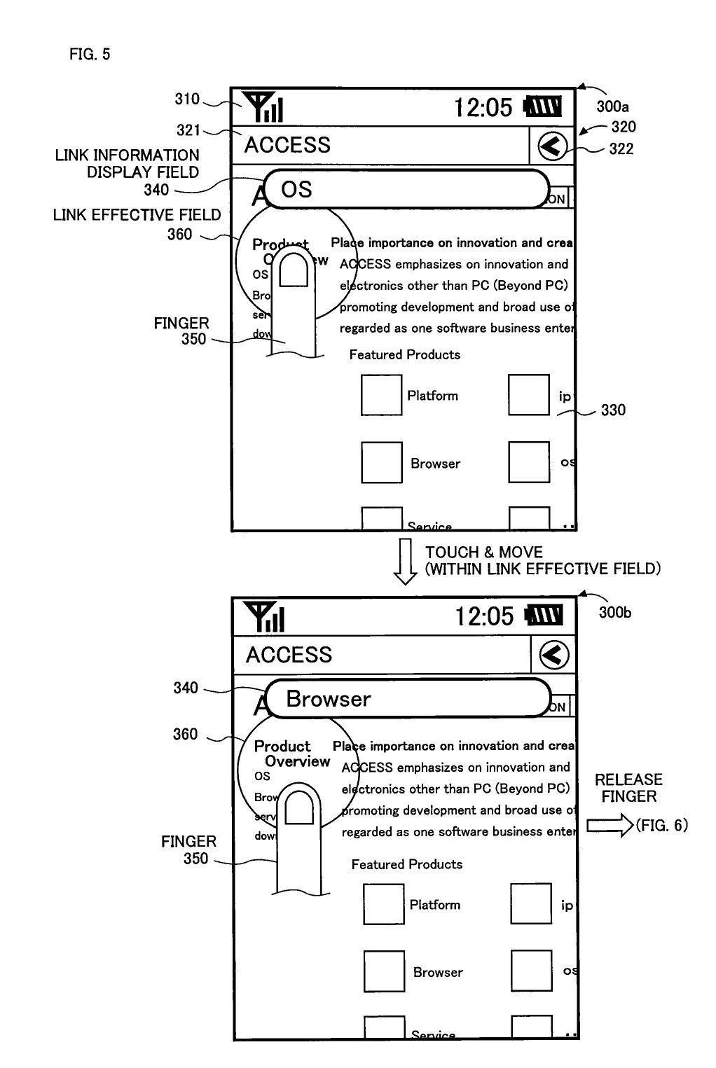

FIG. 5 illustrates an example of a major operation according to the present embodiment. The screen 300a in the figure is the same as the screen shown in FIG. 4. It is now assumed that a user makes a touch on the screen 300 at the portion provided with a link “Browser” on the upper-left side of the screen by his or her finger 350, and tries to make transition to the screen showing the contents of the “Browser”. On this occasion, the link effective field 360 is displayed, defining a predetermined range including the touch position. The “link effective field 360” in the present specification indicates that a link selection is allowed only within the link effective field which defines the predetermined range including the touch position. This link effective field is displayed so that the user can identify the link effective field when

In this particular example, a circle having a predetermined radius centering the touch position is displayed as an example for displaying the link effective field 360.

As a specific display mode of the link effective field 360, it may be displayed while emphasizing the inside of the circle. The inside of the circle may be emphasized in such a manner as displaying the inside of the circle with a high brightness (highlighting), displaying the outside of the circle with a low brightness, displaying the inside of the circle being inverted, displaying the inside of the circle with a color variation, or the like. It is to be noted that the link effective field 360 is a circular shape, but it is not limited to this circular shape, and for instance, an elliptical shape, a quadrilateral shape, a polygonal shape such as a pentagon or more may be applicable. The size of the link effective field 360 may be fixed in advance, but it may be variable under a predetermined condition as described below. Alternatively, the user may be allowed to select a size from multiple sizes in the initial setting.

As for the link which is determined as being designated according to the touch by the finger 350, the link information of the designated link is displayed within the link information display field 340. Accordingly, even when any character string being touched is hard to identify due to the finger hiding the character string, it is easy to confirm whether the touched link is desired one or not.

In this particular example, the link information display field 340 is temporarily displayed as a window at a fixed position (on the upper edge portion of the main field 330 in the example of the figure). The position of the link information display field 340 is not limited to the position as described above. The position of the link information display field 340 may be dynamically changed, such as in proximity to the touch position.

In the example shown in the figure, it is determined that the touch position of the finger 350 belongs to the portion provided with the link “OS”, which is adjacent to the link “Browser” on the upper side thereof, and “OS” is displayed within the link information display field 340.

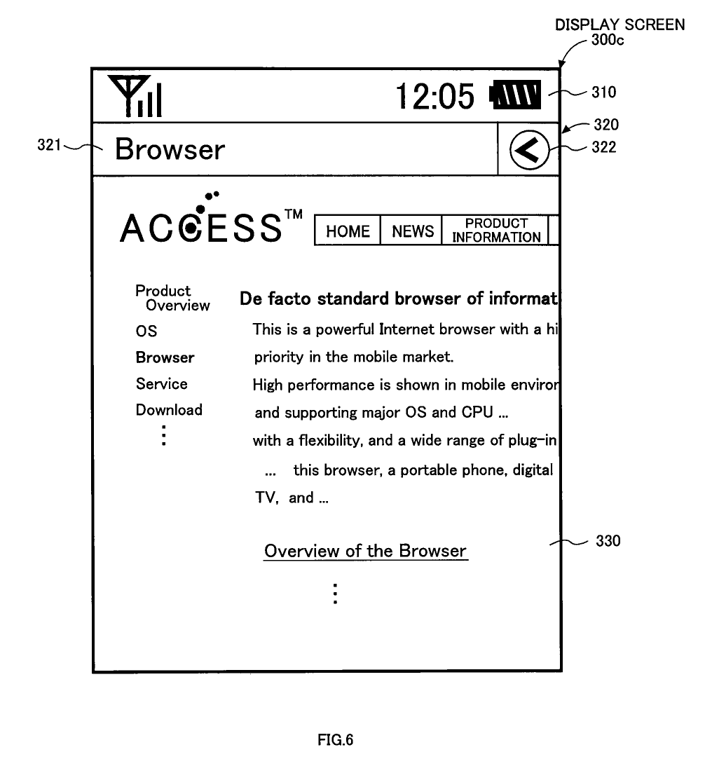

In this state, the user determines that the link is not a target link, and as shown in the screen 300b, the finger 350 is moved downwardly while keeping the touched state. When the touch position is moved to the next portion provided with the link, the character string “Browser” is displayed within the link information display field 340. Then, the user determines that the target link is successfully designated, and releases the finger 350 from the screen. This a release of touch triggers completion of the link selection, thereby making transition to the destination of the link which has been in the touched state until just before. FIG. 6 illustrates the screen 300c showing the link destination. In the screen 300c, the title display field 321 is changed to display “Browser”. A group of character strings on the upper left part of the main field 330 is the same as that of the screen 300a, but the link currently selected is displayed in boldface. As described above, if the browser screen is divided into multiple regions, so called “frames”, it is possible to switch the display for each frame. However, such display in frames is not an essential element in the present invention.

Next, a method of scroll operation according to a touch will be explained.

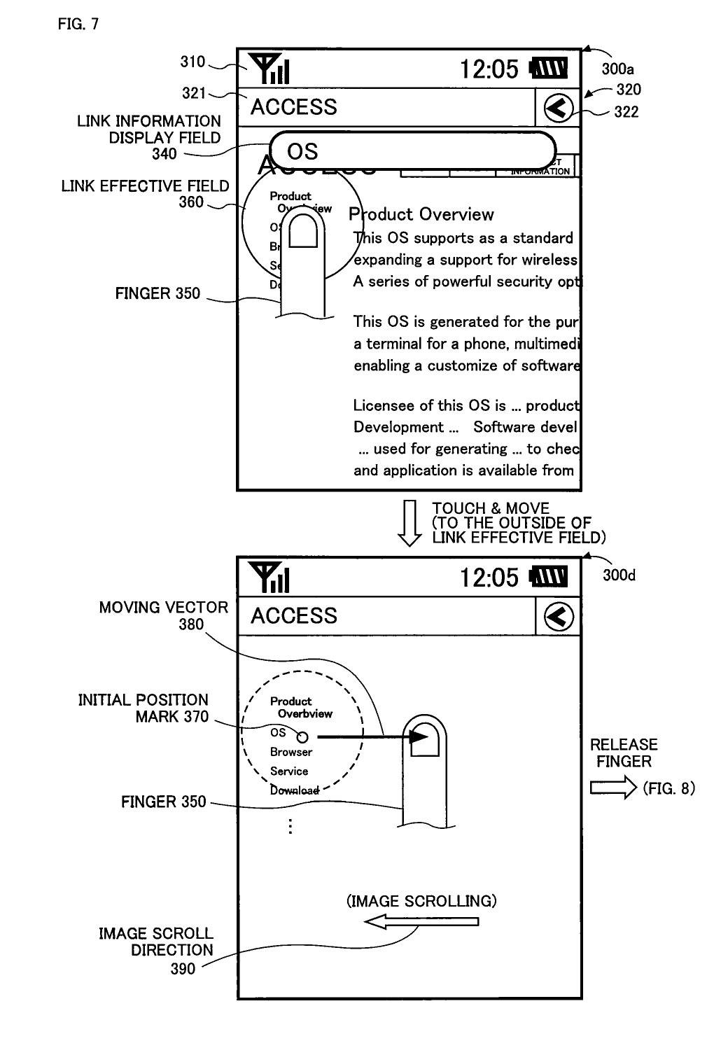

Now, it is assumed that a user wants to scroll the image to the left side in order to view a part of the Web page hidden on the right side of the screen in the screen 300a shown in FIG. 7. On this occasion, similar to the previous example, the link effective field 360 is displayed at the time of touch by the finger 350. In this state, the user moves the finger 350 outwardly from inside the link effective field 360, while keeping the touched state. Such operation as described above is similar to the operation referred to as “drag” which moves the cursor while keeping a click button of a mouse. The screen 300d illustrates that the finger 350 is moved in the right side direction up to the position which goes over the link effective field 360. On this occasion, an initial position mark 370, being a predetermined mark representing the initial position, is displayed at the initial touch position. The “initial touch position” indicates a touch position when a touch on the touch panel is performed at a certain point of time, and it is intended to exclude a subsequent touch position being changed while the touched state is continued.

In this example here, the initial position mark 370 is represented by a relatively small circle, but the shape or color thereof is not particularly limited. It is to be noted here that the initial position mark 370 is determined by the coordinates on a coordinate system of a physical display screen, and the mark does not move even though the image moves. In the present embodiment, when the touch position goes outside the link effective field 360, the display of the link effective field 360 is eliminated. However, this elimination is not essential, and another embodiment may be considered such as just keeping the display.

When the scrolling is instructed and the operation is performed, it is possible to assume a moving vector 380 which extends from the initial position to the destination position of the touch. This moving vector 380 is just envisaged for the sake of convenience, and it is not actually displayed on the screen. In the present embodiment, a scrolling speed is determined in accordance with the length of the moving vector 380 (i.e., a distance from the initial position to the destination position of the touch), and the scrolling direction 390 is backward relative to the moving vector 380. This scrolling direction 390 is shown for the sake of convenience, and it is not necessary to actually display the scrolling direction. On the screen 300d, the image flows from the right to the left by scrolling, but illustration of this scrolling state is omitted.

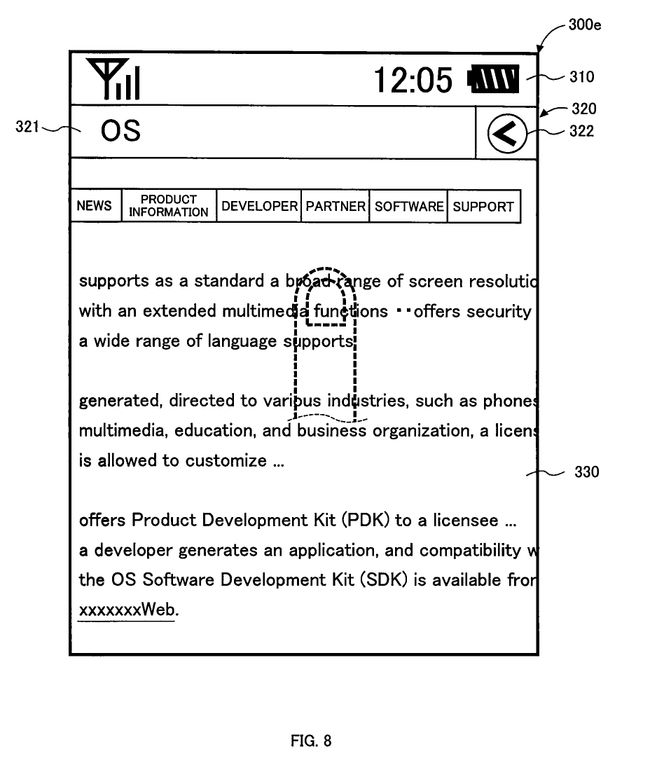

When the finger 350 is released from the touch panel in the course of scrolling, the scrolling is halted as shown in the screen 300e in FIG. 8. In other words, when a desired Web page part appears on the screen after the user starts the scroll, all the user has to do is just release the finger 350. Here, following usage is available; if there is a certain distance up to the desired Web page part, the user places the finger far away from the initial position (mark 370) thereby speeding up the scrolling. When the desired Web page part becomes close, the user makes the finger position to be closer to the initial position (out of the link effective field), thereby slowing the scrolling speed.

It is to be noted that when the display image of the Web page moves and subsequently the edge thereof appears within the display screen, scrolling is stopped without moving the image any further, irrespective of the touched state. The scrolling direction is not limited to the horizontal direction, and it may be vertical direction or oblique direction.

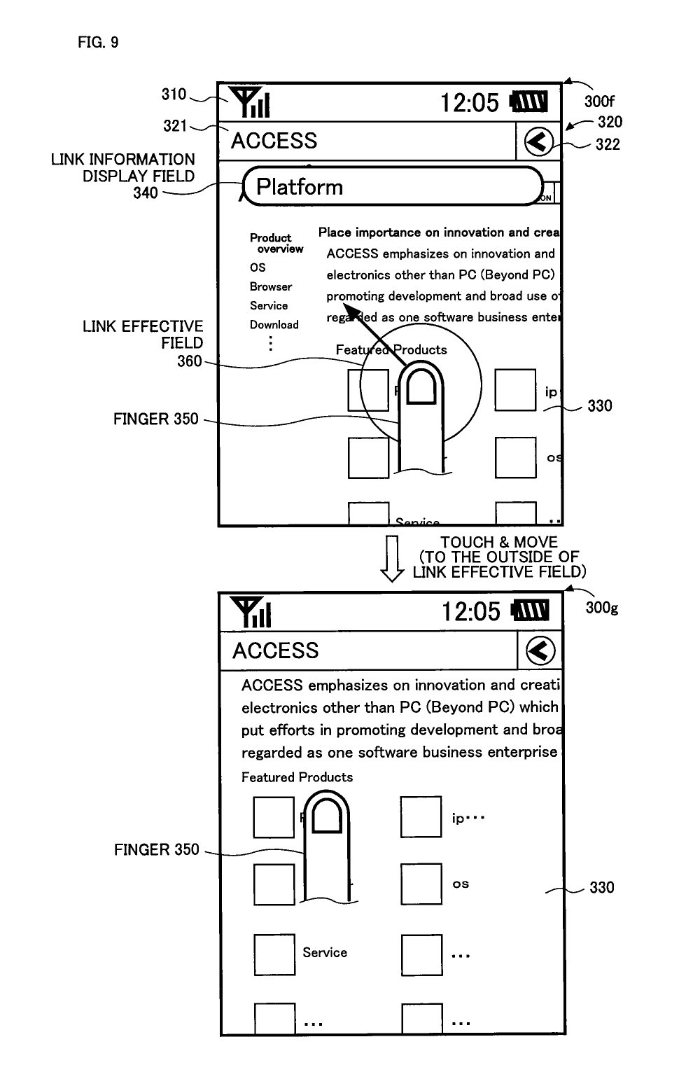

Next, with reference to FIG. 9, an example of a second scroll operation according to the present embodiment will be explained. The second scroll operation substitutes for the previous (the first) scroll operation. In the first scroll operation, scrolling continues, while the finger, which has moved outside the link effective field, is still in the touched state. On the other hand, in the second scroll operation, the scrolling is performed in synchronization with movement of the finger, only during the time when the finger is moving. Here, the term “synchronization” indicates that a moved distance and a moving direction of the finger agree with those of the display image in real time.

As shown in the screen 300f of FIG. 9, the finger 350 makes a touch on one point on the browser screen, and while keeping this touched state, the finger 350 is moved in the direction of the moving vector 380, going over the boundary of the link effective field 360, and the image is scrolled in the moving direction only by the moved distance, as illustrated by the screen 300g. As far as the touch of the finger 350 is maintained, it is possible to further continue the scroll operation. If the touch is released, the scrolling process is terminated. When the next touch is made, the operation is started again from displaying the link effective field. As thus described, in the second scroll operation, unlike the first scroll operation, the moving direction of the scrolling becomes equal to the moving vector 380. This operation looks like an action such as sliding by a hand a sheet of paper with an image thereon.

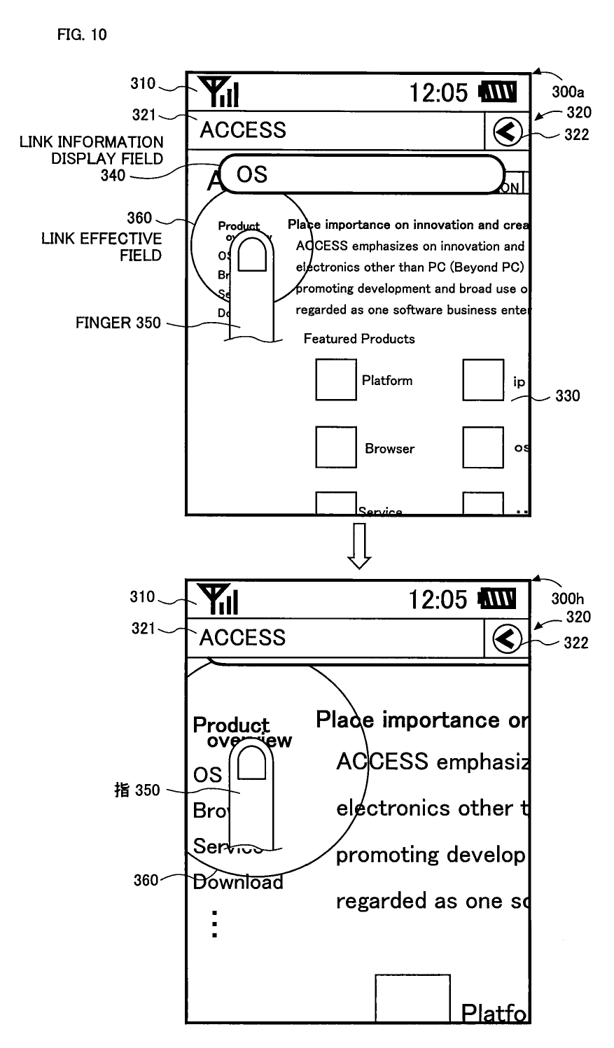

Next, with reference to FIG. 10, a modification example will be explained for the sake of convenience when a link is selected. As shown in the screen 300a, in the case where a touch is made by the finger 350 on a region which is relatively dense with multiple portions each provided with a link, the finger 350 is required to be moved by a minute amount when the touch is made erroneously on an adjacent link, as described in the previous example. In the case as such, there is a possibility that the finger passes over the target link, making it difficult to perform an immediate and accurate designation. Therefore, as shown in the screen 300h, when the touch is made onto the touch panel, a display image of the document data is temporarily enlarged by the display unit under a predetermined condition. At the time of enlargement, the link effective field 360 is enlarged together. The center for enlarging the display image is assumed as the initial position. As the predetermined condition, specifically, the number of the portions each provided with a link belonging to the link effective field 360 is counted, and when the number of the portions becomes equal to or larger than a predetermined value, the display image is enlarged. In addition to or instead of the condition above, the display image may be enlarged when the touch area becomes equal to or larger than a predetermined value. This is effective for the case where the size of finger is various depending on the user and the user's finger is too large to give a sensitive touch for designating a portion provided with a link. When a finger moves to the outside of the link effective field 360, the display image is rescaled to original size (100%).

In addition, though not illustrated, while keeping the scale of the display image to 100%, only the link effective field 360 may be enlarged and displayed under a predetermined condition. By way of example, in the case where the portions each provided with a link, the number of which is equal to or more than a predetermined number, are included in the link effective field 360, the size of the link effective field 360 is temporarily enlarged. With such enlargement, even when a portion provided with a link, which is tried to be designated, is some distance from the touch position and therefore it has been out of the link effective field 360 before enlargement, the designation becomes possible without necessity of making a second touch. It is further possible to enlarge the size of the link effective field 360 temporarily, according to the touch area. This configuration may avoid a situation that the link effective field 360 looks cramped, in the case where a finger of the user is thick.

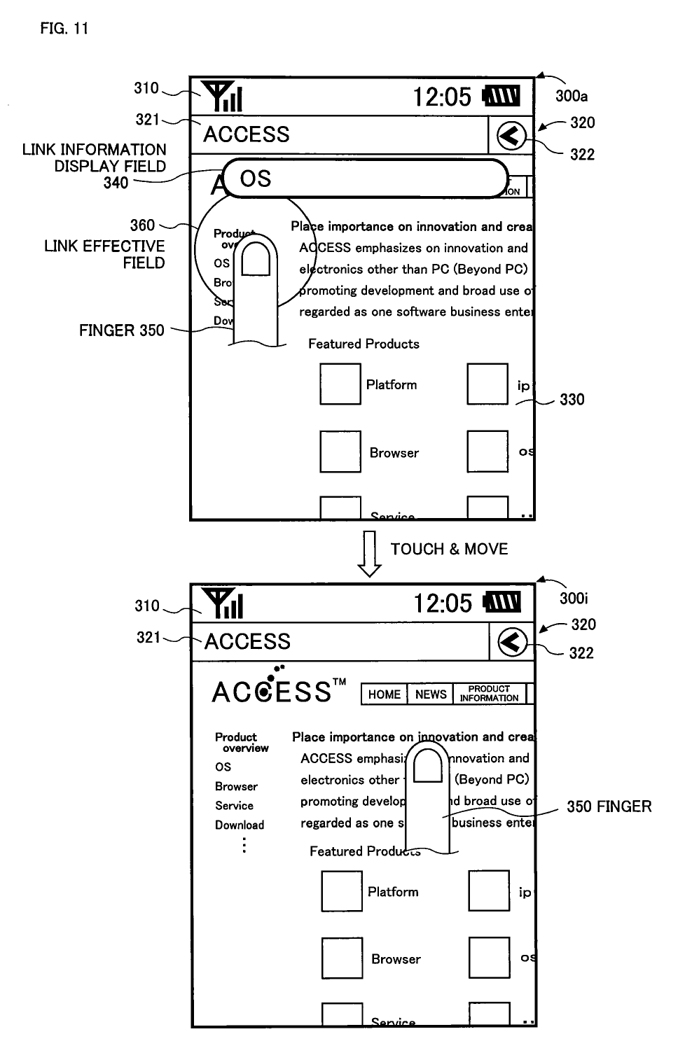

FIG. 11 illustrates a modification example relating to whether the link effective field is set or not. In the example described above, wherever the touch is made on the browser screen, the link effective field 360 is set and displayed at the time when the touch is made. However, even though a user wants to perform the scroll operation from the beginning, the link effective field 360 is always displayed when a touch is made. Therefore, there is a possibility that unintended moving to a link destination is performed when the finger is erroneously released within the link effective field 360 upon moving the finger toward the link effective field 360. On the other hand, there are a lot of regions within the browser screen, in which no portions provided with a link exists. Therefore, the number of portions each provided with a link within the link effective field 360 is counted, and no effective field 360 is set when the count value is zero. By way of example, it is further possible to configure such that the size of the link effective field 360 is kept unchanged, and the function itself of the link effective field 360 is disabled and the scroll operation immediately after the touch is activated. Alternatively, it is possible that the size of the link effective field 360 is set to be zero (the radius is made to zero), thereby not displaying the link effective filed. If the size is zero, the scroll operation is enabled immediately after the movement of the touch. In any event, as shown in the screen 300i of FIG. 11, when the touch is made by the finger 350 on the region where there is no portion provided with a link, the link effective field is not displayed, and the scroll operation is enabled immediately without considering the position on or off the link effective field. This scroll operation may correspond to any of the first and second scroll operations described above.

The description above shows an example that when the touch is moved over the boundary of the link effective field, the scrolling process of the display image is performed as the predetermined process, which is an alternative of the link selecting process. However, the predetermined process other than the link selection is not limited to the scrolling process. By way of example, modification of display mode may be considered, such as scaling of the display, and rotation of the display (e.g., rotation by 90 degrees). It is further possible to consider a configuration that setting of the link effective field is simply canceled when the touch goes out of the boundary. In addition, a processing for switching the display screen is also one example of the “predetermined process”. By way of example, in a case where browsing history is stored, this browsing history may be used to switch the display image according to the operations such as “forward” and “backward” operations. Specifically, when the finger in the touched state within the link effective field moves outside, passing over the left side boundary of the link effective field, it is possible perform the “backward” operation, and when the finger move outside, passing over the right side boundary, it is possible to perform the “forward” operation. As thus described, if there is a choice of options for the “predetermined process”, a selection can be made depending on the direction in which the touch moves, when going out of the boundary.

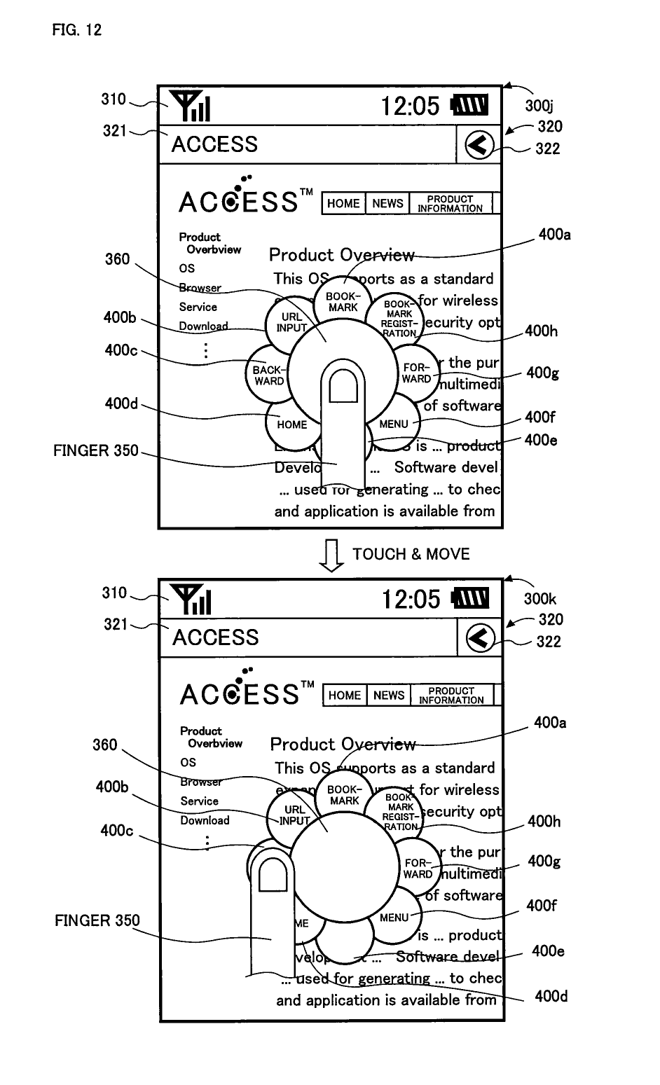

FIG. 12 illustrates a display example in the case where menu items are displayed relating to document data display and processing is performed for making a selection, as one of the “predetermined process”.

As illustrated in the screen 300j shown in FIG. 12, at the time of the initial touch, the link effective field 360 centering the touch position is displayed, and at the same time, on the periphery thereof, menu icons 400a to 400h are displayed which represent multiple menu items. Here, eight menu icons 400a to 400h are generically called as a menu field 400. The number, size, shape of the menu icons, and the descriptions and arrangement of the menu items are not restricted to those illustrated in the figure.

Each of the menu items and the positions thereof are designed as the following. In other words, they are arranged from the uppermost icon in the anti-clock direction; (1) bookmark, (2) URL input, (3) backward, (4) home, (5) reload, (6) menu, (7) forward, and (8) bookmark registration. Preferably, the items “backward” and “forward” are located at the positions opposed to each other, being symmetric with respect to a point (in the example shown in the figure, they are located on the left and right opposed to each other). There is not a particular restriction for the arrangement with regard to other menu items. The character information representing the name of each function is not necessarily provided, and signs or marks may be applicable.

Functions for the respective menu items when touched by the user are as the following:

### (1) Bookmark

A bookmark is referable. By way of example, a list of bookmarks (not illustrated) is displayed.

### (2) URL Input

A software keyboard (not illustrated) provided with an URL input part, is displayed.

### (3) Backward

The Web page being displayed is returned to the page previous to the currently displayed Web page, according to the browsing history. Typically, the browsing history is stored in the storage unit.

### (4) Home

When this icon is touched before starting the browser, the browser is started, and the Web page of the URL designated in the “Home” is displayed. When this icon is touched when the browser is already started, the display is switched to the Web page designated in the Home.

### (5) Reload

An update processing is performed by acquiring once again a request of the markup language document having the URL of the Web page being currently displayed, and displaying the Web page.

### (6) Menu

A submenu is displayed.

### (7) Forward

The Web page being displayed is forwarded to the page next to the currently displayed Web page based on the browsing history (for instance, in the case where the “Backward” process is already performed, e.g., Web page A→B→C→“Backward”→B→“Forward”→C).

### (8) Bookmark Registration

The Web page (i.e., URL thereof), currently displayed, is registered as a bookmark.

The finger is moved to the icon position of any one of the menu items, starting from the initial touch position, going over the boundary of the link effective field 360, and the finger 350 is released at the icon position. Then, the menu item assigned to the icon is performed. The screen 300k shows an example where the finger 350 which once made a touch is moved to the left side, and released within the icon 400c for the “Backward” menu item, thereby performing the “Backward” operation. With the configuration above, it is possible to perform an operation for selecting from the menu items which are collected at any position on the browser screen (but the position is limited to the place where necessary menu items can be displayed).

Features of the menu selection as shown in FIG. 12 may be used in combination with the features of the first and the second scroll operations described above. However, the scrolling process is not performed within the menu field 400. In other words, after making the touch, when the touch is moved from the initial position to the outside of the menu field 400, any of the scroll operations as described above is executable. It is to be noted that non-setting and/or non-display of the link effective field 360 as described with reference to the screen 300i in FIG. 11 are not employed in the case of the menu display shown in FIG. 12.

Hereinafter, with reference to a flowchart, an explanation will be made regarding an example of processing procedure for implementing various processes discussed above.

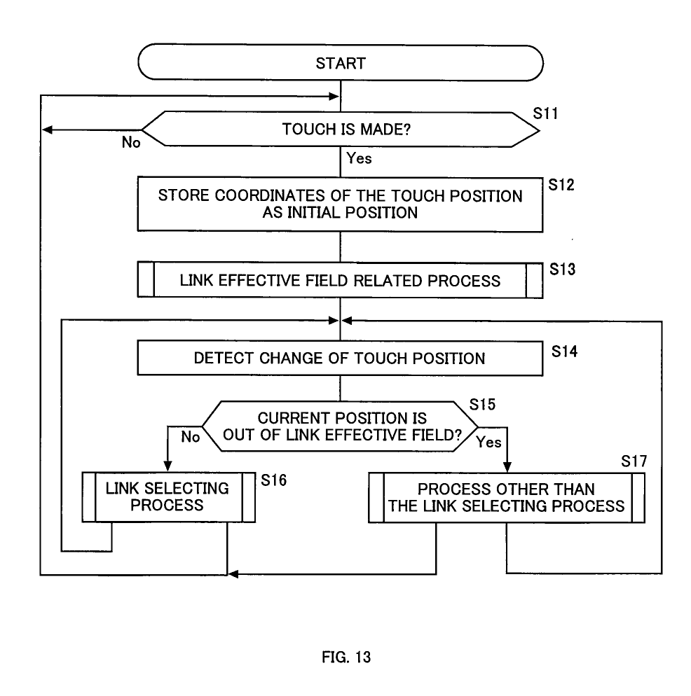

FIG. 13 is a flowchart showing a basic processing of the present embodiment. This processing is to perform switching between the link selecting process and other process. Firstly, when a touch is made on the browser screen (S11, Yes), coordinates of the touch position are stored as an initial position (S12). Subsequently, the link effective field related processing unit 133 (FIG. 3) performs the link effective field related processing (S13). A specific internal process thereof will be described below. Then, a change of the touch position while keeping the touched state is periodically detected (S14). It is determined whether or not the current touch position goes out of the link effective field (S15). If the current touch position remains in the link effective field, the link selecting process is performed (S16). If the current touch position is out of the link effective field, a process other than the link selecting process is performed (S17). After the execution in any of steps S16 and S17, the process returns to step S11 or step S14 according to a result of the execution. Detailed examples of both processes above will be described below. It is to be noted that for the sake of convenience in describing the flowchart, detection of the touch position is indicated as one step (S14) in the flow shown in FIG. 13. However, in effect, the detection of the touch position can be periodically performed, independently of and in parallel with the processing shown in FIG. 13.

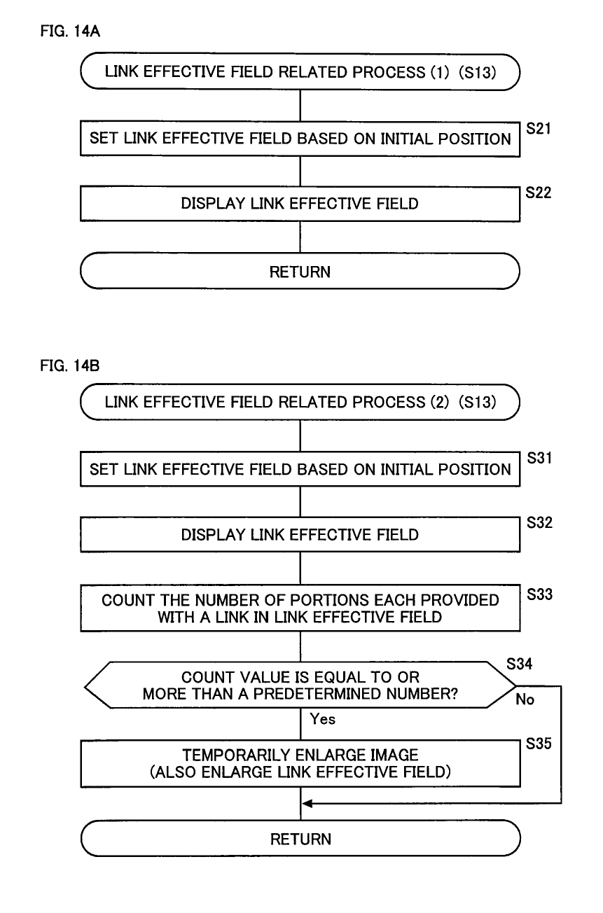

FIG. 14(a) and FIG. 14(b) are the flowcharts showing the link effective field related processes (1) and (2), substitutable one for another, in association with step S13 shown in FIG. 13.

In the link effective field related process (1) as shown in FIG. 14(a), firstly, the link effective field is set based on the initial position (S21). Specifically, the center position of the link effective field is made to agree with the initial position, and the display information of the link effective field is generated. Subsequently, the link effective field is displayed (S22).

The link effective field related process (2) as shown in FIG. 14(b) corresponds to the processing which is explained with reference to FIG. 10. In this processing, similar to the link effective field related process (1), the link effective field is set based on the initial position (S31) and the link effective field is displayed (S32). In addition, the number of the portions each provided with a link, which belong to the link effective field, is counted (S33). If the count value is equal to or more than a predetermined number (S34, Yes), the display image is temporarily enlarged together with the link effective field (S35).

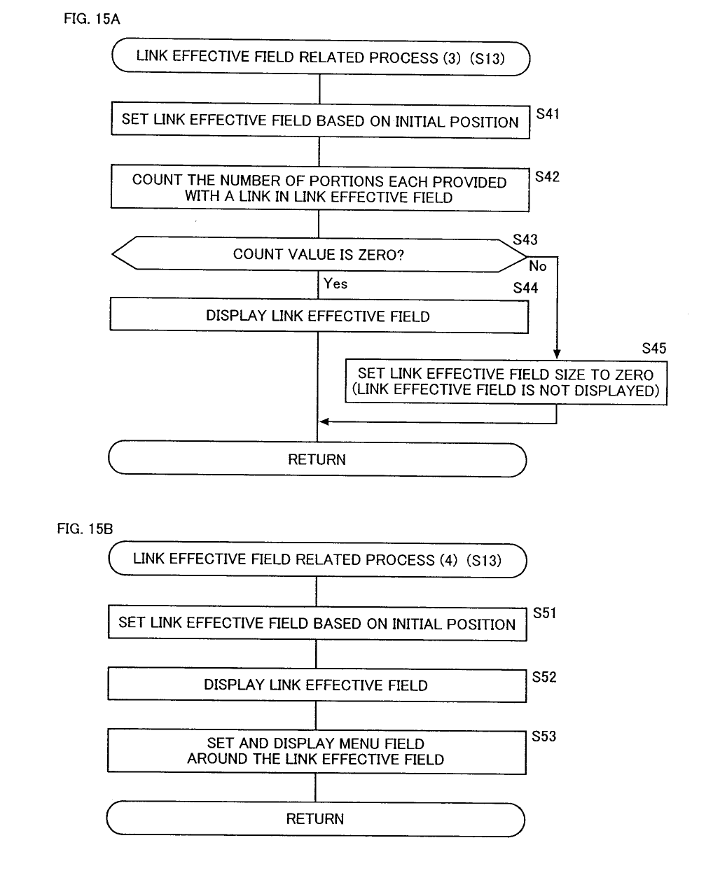

FIG. 15(a) and FIG. 15(b) are the flowcharts showing the link effective field related processes (3) and (4), substitutable one for another, in association with step S13 shown in FIG. 13.

The link effective field related process (3) as shown in FIG. 15(a) corresponds to the processing as explained with reference to FIG. 11. In this processing, firstly, the link effective field is set based on the initial position (S41), and subsequently, the number of portions each provided with a link within the link effective field is counted (S42). If the count value is not zero (S43, No), the link effective field is displayed (S44). If the count value is zero, the size of the link effective field is made to zero (S45). The link effective field is not displayed.

The link effective field related process (4) as shown in FIG. 15(b) corresponds to the menu selecting process as explained with reference to FIG. 12. In this processing, firstly, the link effective field is set based on the initial position (S51), and the link effective field is displayed (S52). Subsequently, the menu field 400 (FIG. 12) is set and displayed around (on the outer periphery of) the link effective field (S53).

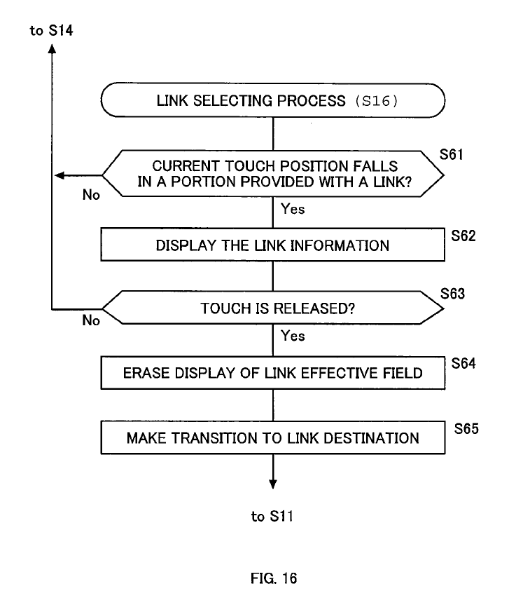

FIG. 16 is a flowchart showing a detailed processing example of step S15 shown in FIG. 13. In this processing, firstly, it is checked whether or not the current touch position corresponds to the portion provided with a link (S61). If it corresponds to the portion provided with a link, the information of the link is displayed in the link information display field 340 (FIG. 5, etc.) (S62). If it does not correspond to the portion provided with a link, the processing returns to step S14 in FIG. 13. Subsequent to step S62, it is checked whether or not there is a release of touch (S63). If there is not any release of touch, the process returns to step S14. If there is a release of touch, the display of the link effective field is erased (S64). In addition, transition is made to the link destination (S65). Thereafter, the process returns to step S11. It is to be noted that if the overall browser screen is rewritten by the transition to the link destination, the process of step S64 may be omitted.

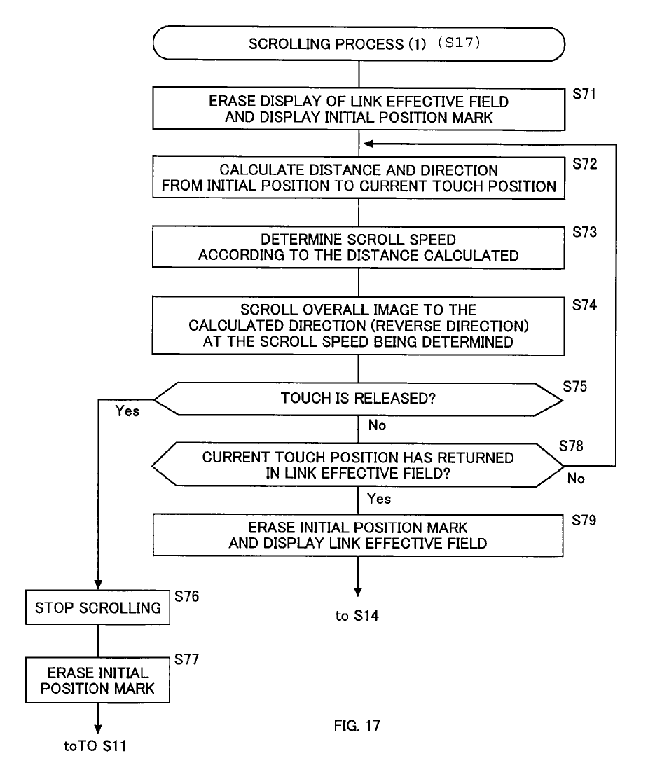

FIG. 17 is a flowchart showing the scrolling process (1) as a processing example of step S16 shown in FIG. 13. This process corresponds to the first scroll operation described above.

Firstly, the display of the link effective field is erased, and a predetermined initial position mark 370 (FIG. 7) is displayed (S71). Next, a distance and direction from the initial position to the current position of the destination, i.e., a moving vector 380 (FIG. 7) is calculated (S72).

According to the distance being calculated, a scrolling speed is determined (S73). Typically, the longer is the distance, the higher is the scrolling speed. This relationship may be linear, or stepwise. At the scrolling speed being determined, the total image is scrolled in the direction which is opposite to the direction being calculated (S74).

When there is a release of touch during the scroll operation (S75, Yes), the scrolling is halted (S76). Furthermore, the initial position mark is erased (S77), and the processing is returned to step S11.

If there is no release of touch, it is continuously checked whether or not the current touch position has returned inside the link effective field (S78), and the processing above is repeated, going back to step S72, until the current touch position returns inside the link effective field. When the current touch position returns inside the link effective field, the initial position mark is erased, again the link effective field is displayed (S79), and then, the processing returns to step S14.

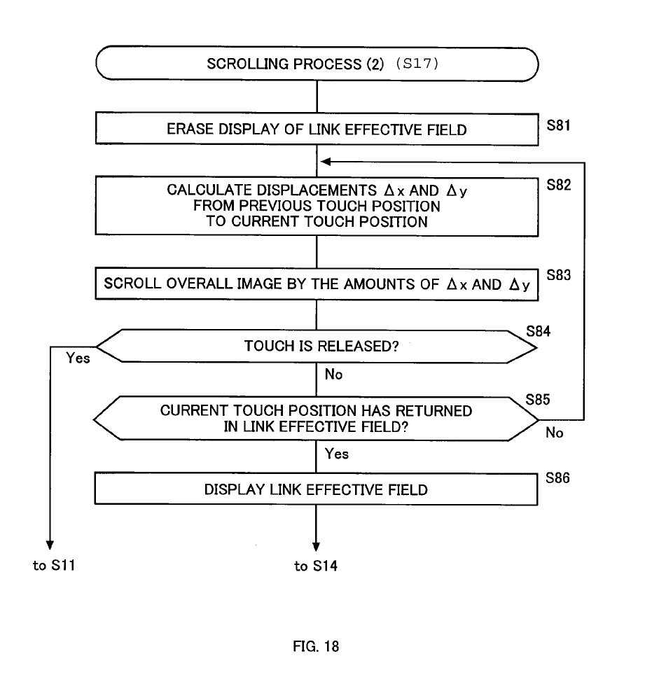

FIG. 18 is a flowchart showing the scrolling process (2) as a processing example of step S16 shown in FIG. 13.

Firstly, the display of the link effective field is erased, and the initial position mark 370 (FIG. 7) is displayed (S81). Next, displacements Δx and Δy from the previous touch position to the current position are calculated (S82). Next, the overall image is scrolled only by the displacements Δx and Δy (S83). When there is a release of touch during the scroll operation (S84, Yes), the processing returns to step S11. If there is no release of touch, it is continuously checked whether or not the current touch position returns inside the link effective field (S85), and the processing above is repeated, going back to step S82, until the current touch position returns inside the link effective field. When the current touch position returns inside the link effective field, again, the link effective field is displayed (S86), and the processing returns to step S14.

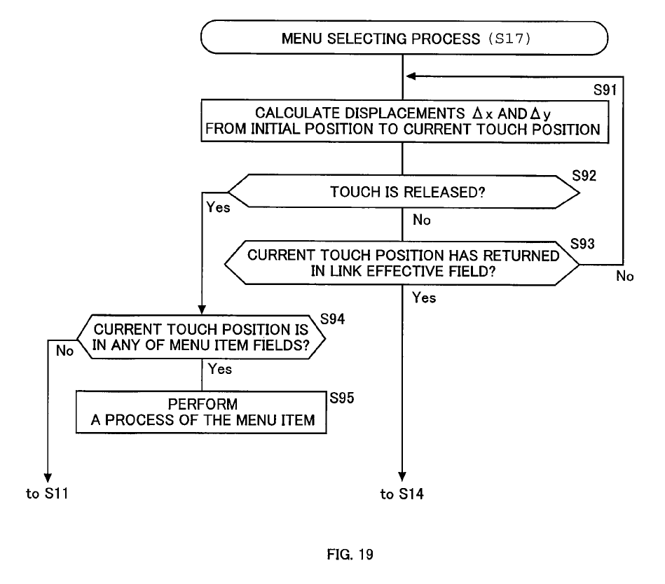

FIG. 19 is a flowchart showing the menu selecting process as a processing example of step S16 shown in FIG. 13.

Firstly, displacements Δx and Δy from the initial position to the current touch position are calculated (S91). Then, it is checked whether or not there is a release of touch (S92). If there is a release of touch, it is checked whether or not the current position is within any of the menu item fields (S94). If the current touch position is within any of the menu item fields, the processing of the pertinent menu item is performed (S95). If the current touch position is not within any of the menu item fields, the processing returns to step S11.

If there is no release of touch, it is checked whether or not the current touch position has returned inside the link effective field (S93). The processing above is repeated, going back to step S91 until the current touch position returns inside the link effective field. When the current touch position returns inside the link effective field, the processing is returned to step S14.

### Second Embodiment

Next, a configuration of a second embodiment according to the present invention will be explained. The external configuration and internal configuration of the terminal apparatus according to the second embodiment correspond to those illustrated in FIG. 1 and FIG. 2.

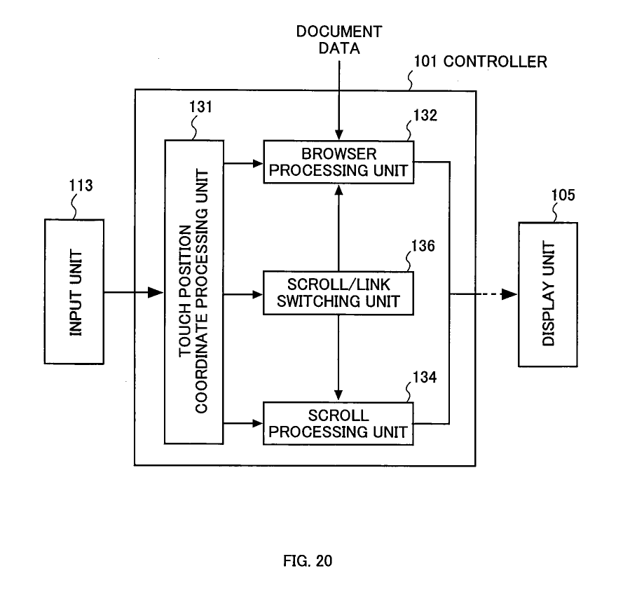

FIG. 20 is a functional block diagram showing key functions of the portable terminal 100 according to the present embodiment. The elements which are the same as those in FIG. 3 are labeled with the same reference numbers.

The functions implemented by the controller 101 include a touch position coordinate processing unit 131, a browser processing unit 132, a scroll/link switching unit 136, and a scroll processing unit 134.

Functions of the touch position coordinate processing unit 131, the browser processing unit 132, and the scroll processing unit 134, are the same as those described above.

The scroll/link switching unit 136 is a unit for switching between a scroll related processing and a link related processing according to a touch operation from the input unit 113.

Hereinafter, with reference to specific examples of display screens, a main operation example as well as an additional operation example and a modification example will be explained sequentially.

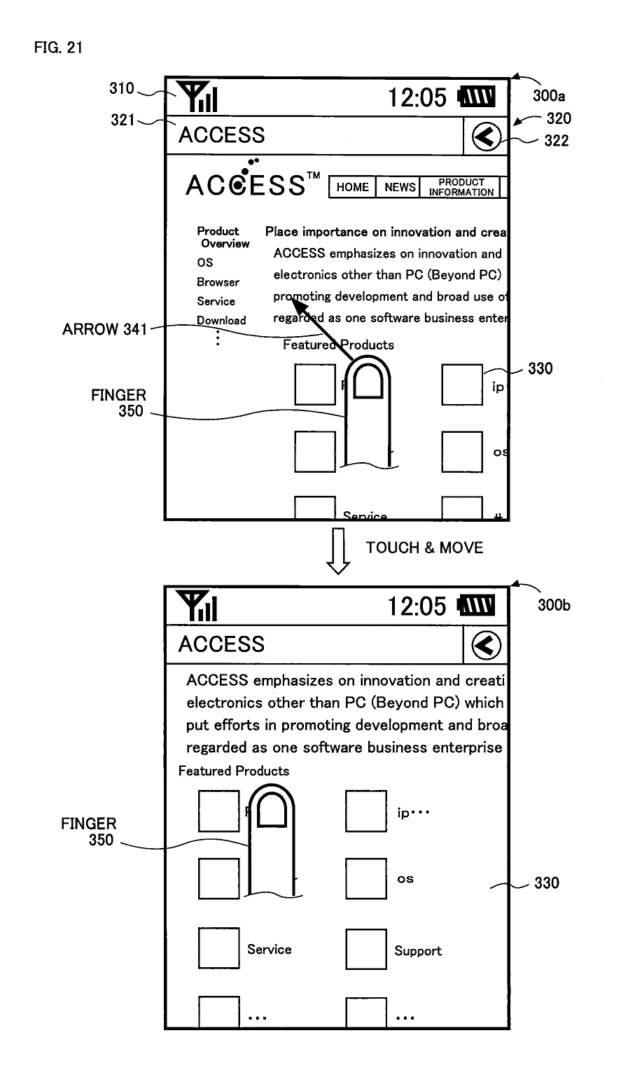

Figures from FIG. 21 to FIG. 24 illustrate screen examples for explaining the main operation according to the second embodiment. A basic display example of the display screen 300 of the portable terminal 100 is the same as the example which is explained with reference to FIG. 4.

FIG. 21 illustrates the main operation example according to the preset embodiment. The screen 300a of this figure is the same as the screen shown in FIG. 4.

Now, it is assumed that in order to view a part at the position hidden in the lower right direction of the Web page being displayed, the scroll operation is performed. In other words, the synchronous scrolling described above is performed, which moves the display image in sync with the movement of the finger, only during the time when the finger is moving.

As shown in the screen 300a of FIG. 21, one point on the browser screen is touched by the finger 350, and the finger 350 is moved in the direction of the arrow 341 while keeping the touched state. Then, the image is scrolled in the moving direction by the moved distance. As shown in the screen 300b, when the finger 350 stops, the scrolling stops too. When the touch is released, the scrolling process is terminated. This scroll operation is just like an operation to allow a sheet of paper with an image thereon to slide by a hand, and it is intuitive and easy to understand. This operation can be carried out over and over again.

It is to be noted that when the scroll operation is performed by one finger, even when the finger touches a portion provided with a link on the Web page, a link designation is not accepted, i.e., the link designation is disabled.

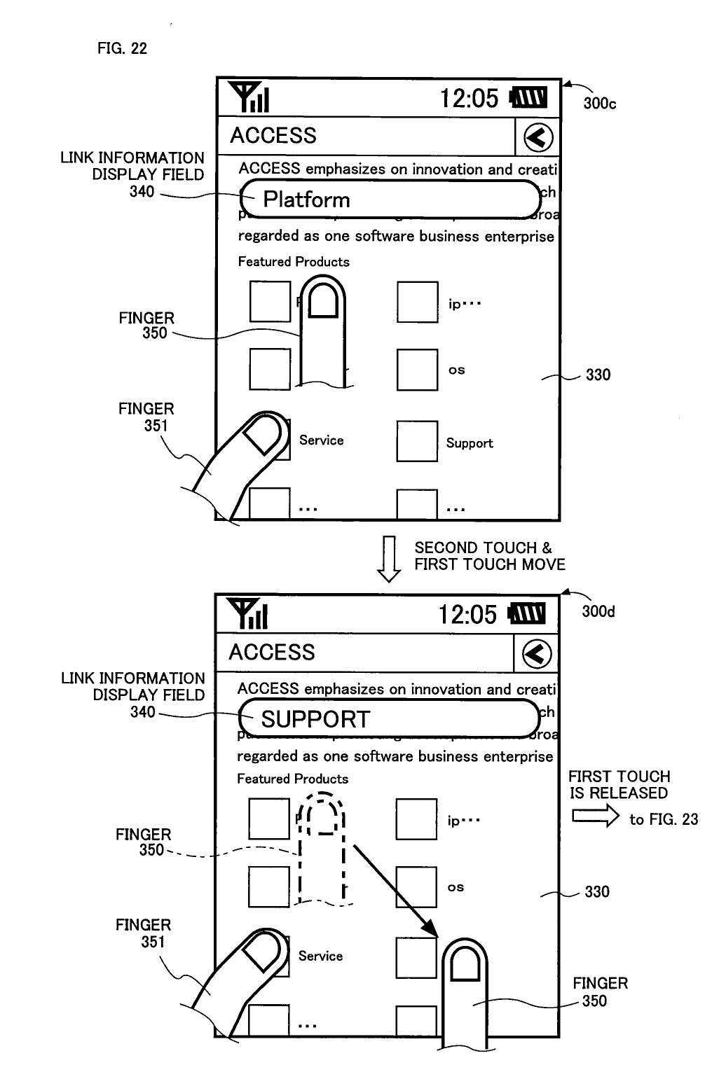

As shown in the screen 300c of FIG. 22, it is assumed that the user touches any position (in the example here, lower-left of the screen) of the screen by another finger 351, while keeping the state of the screen 300b. Typically, the finger 351 is a thumb of the other hand (left hand in the example of the figure) which holds the terminal apparatus, in the case of the portable terminal 100 as shown in FIG. 1. As thus described, when the second touch is performed by the other finger 351 in the state of keeping the touched state by the finger 350, the scroll operation by the first touch is disabled and the link designation by the first touch (being movable) is activated. Accordingly, when the touch position of the first finger 350 corresponds to the portion provided with a link, information representing the link (link information) is displayed in the link information display field 340.

Here, as for the terms “first” and “second” in “the first touch” and “the second touch” in the present specification, if two fingers are in the touched state at a time on the touch panel, the finger which is brought into the touched state earlier is referred to as “first” and the finger which is brought into the touched state later is referred to as “second”.

As described above, the link information display field 340 is displayed, temporarily in the form of window, at a fixed position (in the example of the figure, in the upper edge part of the main field 330). The link information display field 340 is not necessarily located at this position. The position of the link information region 340 may be dynamically changed, such as to a position in proximity to the touch position.

The example of the screen 300c as shown in FIG. 22 illustrates a state that the finger 350 designates the link which is provided on the character string “Platform” in the Web page, and this character string is displayed in the link information display field 340. With the configuration above, even in the case where the character string being touched is hard to be identified because it is covered by the finger, the user is allowed to easily check whether the touched link is desired one or not. It is to be noted that the character string itself, which is provided with a link, is shown as the link information displayed in the link information display field 340, but it is not limited to this configuration. The link information may include the following information:

(1) Character string itself which is provided with a link within the Web page, i.e., the character string “Platform” in the example above;
(2) Title information of the link destination. In the example above, it is “Platform Information”. The title information of the link destination may be included in the original HTML document, or may be acquired from the link destination;
(3) URL of the link destination; and
(4) Any combination of items (1) to (3) described above.

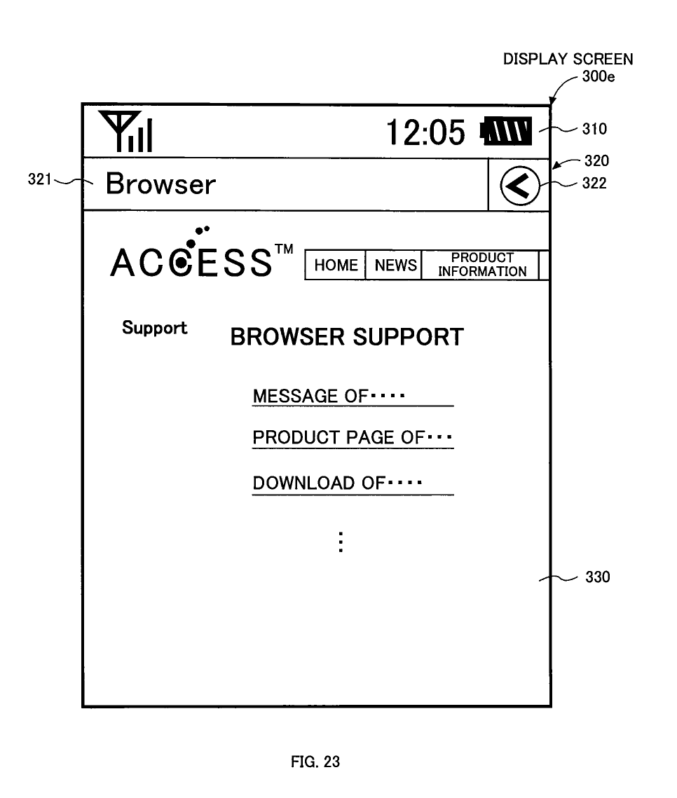

As shown in the screen 300d in FIG. 22, it is assumed that the finger 350 is moved in the arrow direction, while keeping the touched state of both fingers, starting from the state of the screen 300c. On this occasion, since the scroll operation is disabled, the screen is not scrolled, and only the finger 350 moves on the screen. When the finger 350 associated with the first touch reaches a portion provided with a link, the link information thereof is displayed in the link information display field 340. The example shown in the figure illustrates that the finger 350 designates the portion provided with a link “Support” which appears in the screen as a result of the scrolling process. As thus described, if the finger 350 is released from the touch panel after the state where the link is designated by the finger 350, it is determined that selection of the link is made, and a Web page of the link destination is displayed as illustrated by the screen 300e of FIG. 23. It is to be noted that the arrow shown in the screen 300d is illustrated for the sake of convenience and it is not actually displayed.

When the finger 351 (the second touch) is released before releasing the finger 350 (the first touch), the link designation is disabled again, and the scroll operation is allowed to be performed.

In the operation example as shown in FIG. 22 (i.e., a first operation example), there has been explained a case that the finger for scrolling the screen and the finger for designating the link are the same finger 350 which made the first touch. In other words, it is configured such that when the two fingers are in the touched state at a time, a link designation by the finger which made a touch firstly is accepted (in the example of the figure, it is the finger 350). On the other hand, another operation example (i.e., a second operation example) may be considered, that is, when the two fingers are in the touched state at a time, the link is designated by the finger which made a touch later (the second touch).

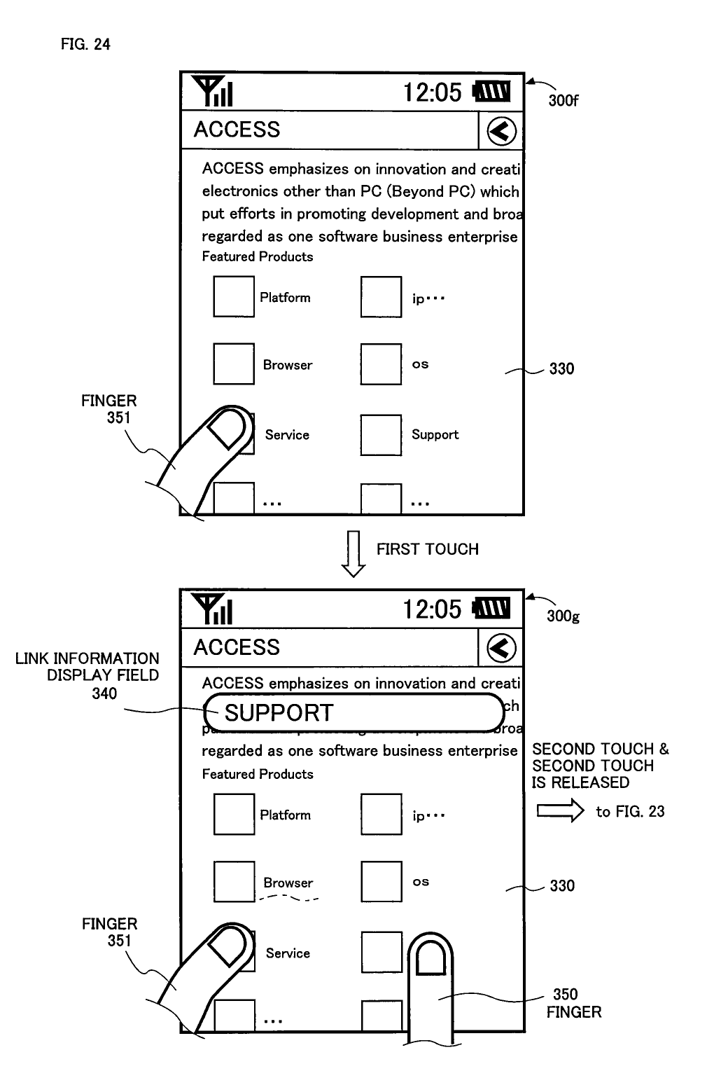

By way of example, the screen 300f of FIG. 24 illustrates the state that the finger 350 is once released from the screen, the finger 350 having just performed the scroll operation in the screen 300b of FIG. 21, and then a touch is made by the finger 351. In the state where only any one finger makes a touch, only the scroll operation is enabled, and link designation is not available. Therefore, if the finger 351 is moved on the screen in the state of the screen 300f, scrolling similar to the aforementioned example can be performed. However, in the example here, it is considered that the touched state of the finger 351 is kept unchanged, and the finger 350 again makes a touch on an arbitrary position. The screen 300g shown in FIG. 24 illustrates an example that the finger 350 makes a second touch to designate a desired link (“Support” in the figure). On this occasion, it is also possible to configure such that the second touch does not directly designate a desired link, but other position is first touched and then the finger is moved to the portion provided with the link.

When the second touch by the finger 350 is released from the screen 300g, moving to the link is started, and the Web page of the destination is displayed on the screen 300e as shown in FIG. 23. According to the second operation example as described above, it is possible to release the finger which has performed the scroll operation, temporarily from the touch panel. Therefore, this configuration is advantageous when a use wants to directly designate a link without performing the scroll operation. On this occasion, it is further possible to consider another operation mode, that is, a finger of one hand performs the scroll operation, keeping the finger after the scroll operation to be placed on the touch panel, and a link designation is performed by a finger of the other hand.

In addition, a third operation example may be considered, though its screen example is not illustrated here. In the first operation example, a link designation by the first touch is accepted, and in the second operation example, a link designation by the second touch is accepted. Here, in the third operation example, a link designation may be accepted according to a touch by any of the two fingers which are in the touched state. In other words, a designation by the touch which is located on the portion provided with a link is activated, and it may be any one of the first touch and the second touch. If both fingers are simultaneously associated with different portions each provided with a link, a predetermined one of the fingers, for example, a finger that has made a later touch, is placed a higher priority. If desired link information is not displayed, it is sufficient to retry the designation to display the desired link information.

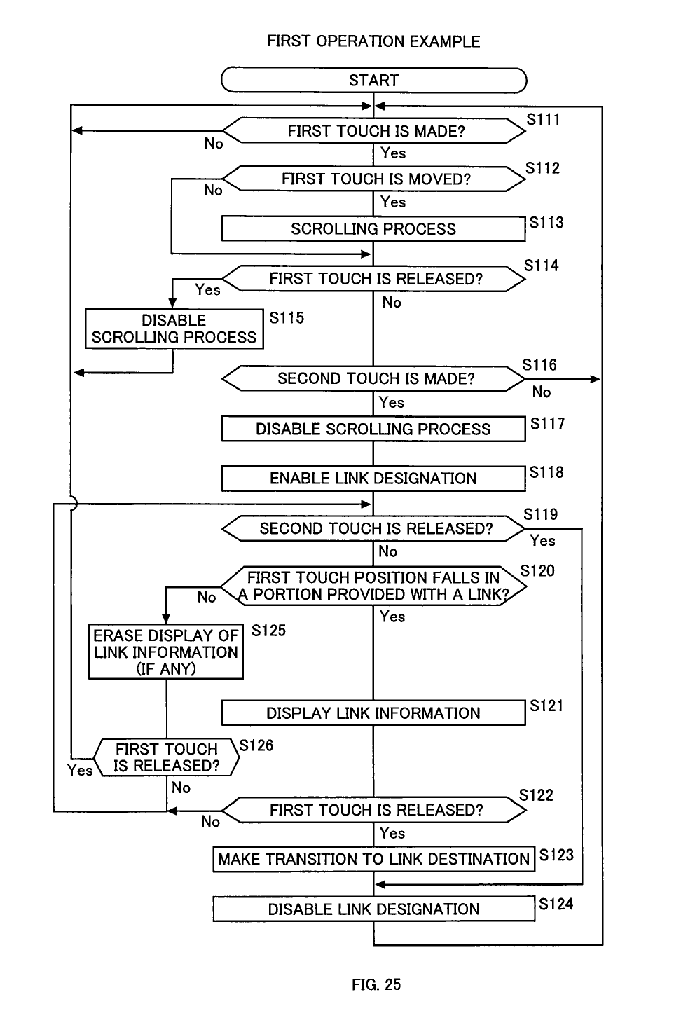

FIG. 25 is a flowchart showing the first operation example according to the second embodiment. This processing is implemented according to software processing in the controller 101 (FIG. 2). The processing in other flowcharts described below is also implemented in a similar manner.

In the processing shown in FIG. 25, firstly, when the first touch is made (S111, Yes), it is monitored whether the first touch position has moved or not (S112). If the first touch position has moved, a scrolling process is performed for scrolling the display image in sync with the movement (S113). This scrolling is assumed as the “synchronous scrolling” described above. Regardless of whether the first touch has moved or not, when the first touch is released (S114, Yes), the scrolling process is disabled (S115), and the processing returns to step S111.

While keeping the first touch, if a second touch is made (S116, Yes), the scrolling process is disabled (S117). In addition, the link designation which has been disabled initially is activated (S118). Thereafter, if the second touch is released (S119, Yes), the link designation is disabled (S124), and the processing returns to step S111. Depending on from which step the procedure goes to step S124, at the time when the processing returns to step S111, a result is different, i.e., either the first touch is maintained or it is not maintained. In step S111, not only when a new first touch is made, but also when the first touch is maintained, it is determined that “the first touch exists”.

In step S119, if the second touch is not released, it is checked whether or not the first touch position falls into the portion provided with a link (S120). This first touch position may vary successively according to the movement of the user's finger. When the first touch position falls into the portion provided with a link, the link information thereof is displayed in the link information display field 340 (S121). If the first touch position does not fall into the portion provided with a link (S120, No), display of the link information is erased in the case where the link information is being displayed at that point of time (S125), and the processing returns to step S119. However, if the first touch is released (S126, Yes), the processing returns to step S111. In the first operation example, the touch that has been the second touch (the touch by the finger 351 of FIG. 22) until now is regarded as the first touch at a point of time when the first touch is released. However, in the first operation example, the remaining second touch at this timing (a touch regarded as the new first touch) is assumed to be released immediately.

In the state where the link information is displayed, if the first touch is released (S122, Yes), it is determined that a link is selected, and tannsition to the link destination is performed (S123). Subsequently, the link designation is disabled (S124), and the processing returns to the initial step S111. Also in this case, the touch that has been the second touch (the touch by the finger 351 in FIG. 22) is regarded as the first touch.

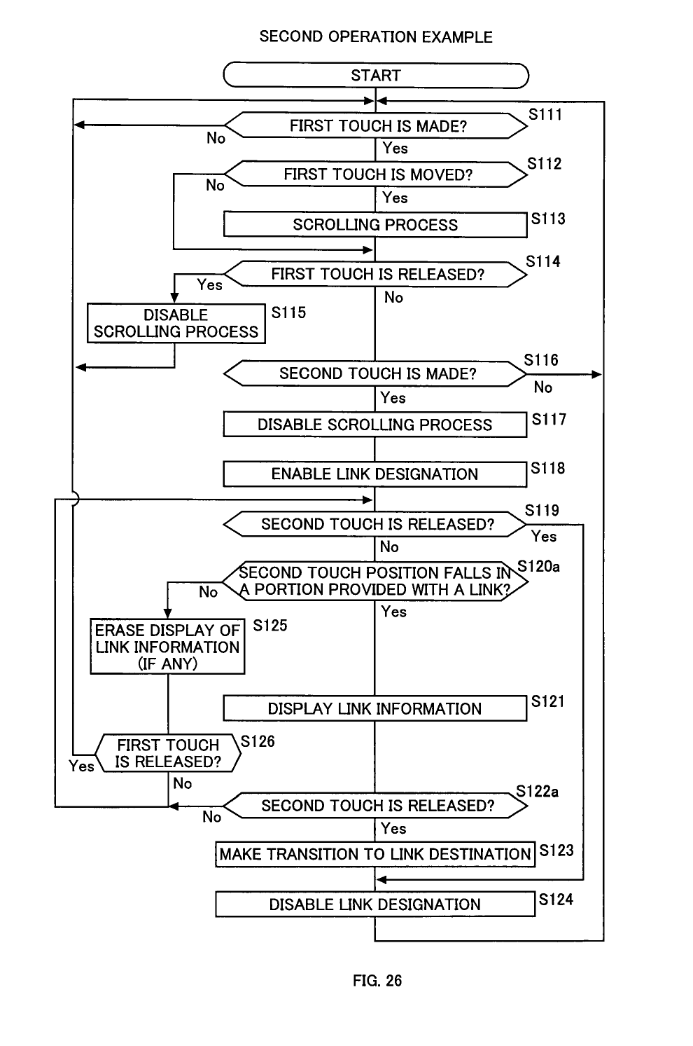

FIG. 26 is a flowchart showing the second operation example according to the second embodiment. Steps which are the same as those of the flowchart shown in FIG. 25 are labeled the same, and tedious explanation will not be made.

The processing of FIG. 26 is different from the processing of FIG. 25 in the points that step S120 and step S122 of the FIG. 25 are respectively changed to step S120a and step S122a. In step S120a, it is checked whether or not the second touch position, not the first touch position, falls into the portion provided with a link. In step S122a, it is checked whether or not the second touch, not the first touch, has been released. Accordingly, in the processing of FIG. 26, a link designation by the second touch is accepted.

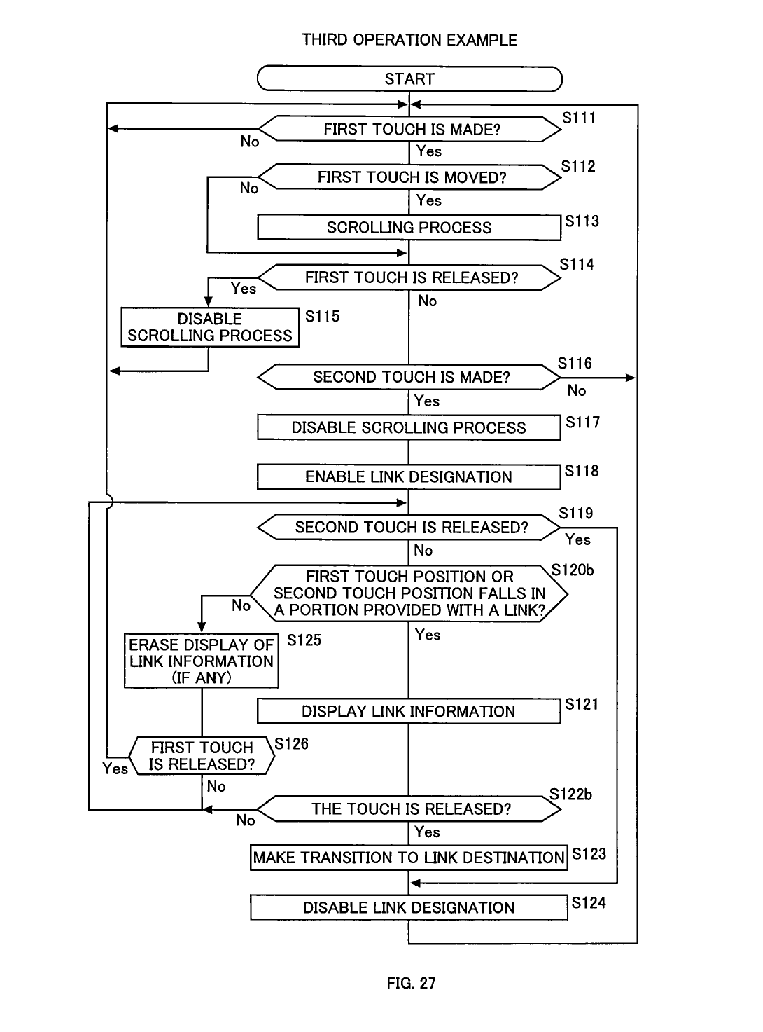

FIG. 27 is a flowchart showing the third operation example according to the second embodiment. Steps which are the same as those of the flowchart shown in FIG. 25 are labeled the same, and tedious explanation will not be made. The processing of FIG. 27 is different from the processing of FIG. 25 in the points that step S120 and step S122 of the FIG. 25 are respectively changed to step S120b and step S122b. In step S120b, it is checked whether or not any one of the first or the second touch position, not the first touch position only, falls into the portion provided with a link. In step S122a, it is checked whether or not the touch in step S120b has been released. Accordingly, the link designation by any of the first touch and the second touch is accepted in the processing of FIG. 27.

As an alternative modification example, it is further possible to configure such that in the case where two fingers are in the touched state at a time the link designation is accepted according to a finger whose touch area is smaller. For example, this configuration corresponds to an operation mode where the pad of thumb of one hand makes a touch, and the tip of forefinger of the other hand performs the link designation. In the case above, which touch triggers the acceptance of the link designation has nothing to do with which touch is performed earlier.

### Third Embodiment

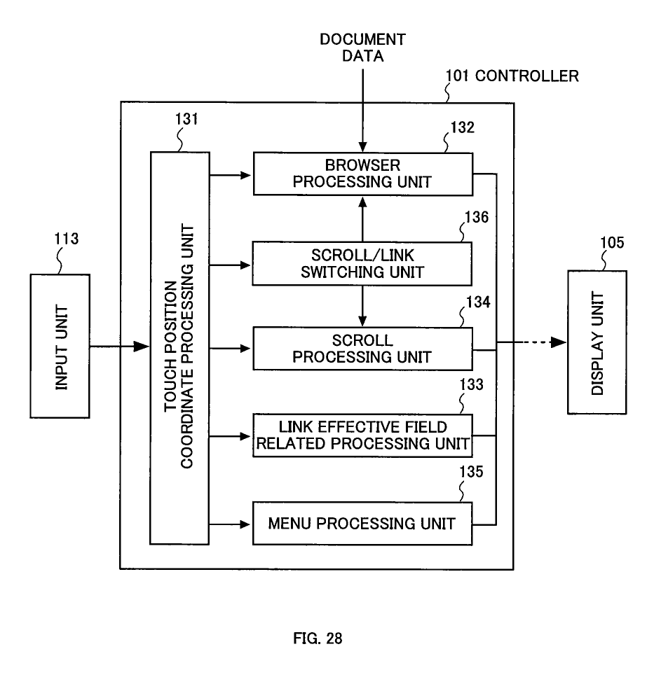

Next, a third embodiment of the present invention will be explained. A configuration of the apparatus is the same as that of the second embodiment, and an explanation will not be made tediously. FIG. 28 is a functional block diagram showing key functions. The elements which are the same as those shown in FIG. 3 and FIG. 20 are labeled the same, and tedious explanations will not be made. In FIG. 28, the link effective field related processing unit 133 and the menu processing unit 135 are added to the configuration shown in FIG. 20. In other words, the present embodiment corresponds to a combination of the first embodiment and the second embodiment. Therefore, key functions of the third embodiment correspond to a combination of the operation of the first embodiment and the operation of the second embodiment.

Hereinafter, with reference to the flowchart, an example of the processing procedure will be explained to implement various processes in the third embodiment described above.

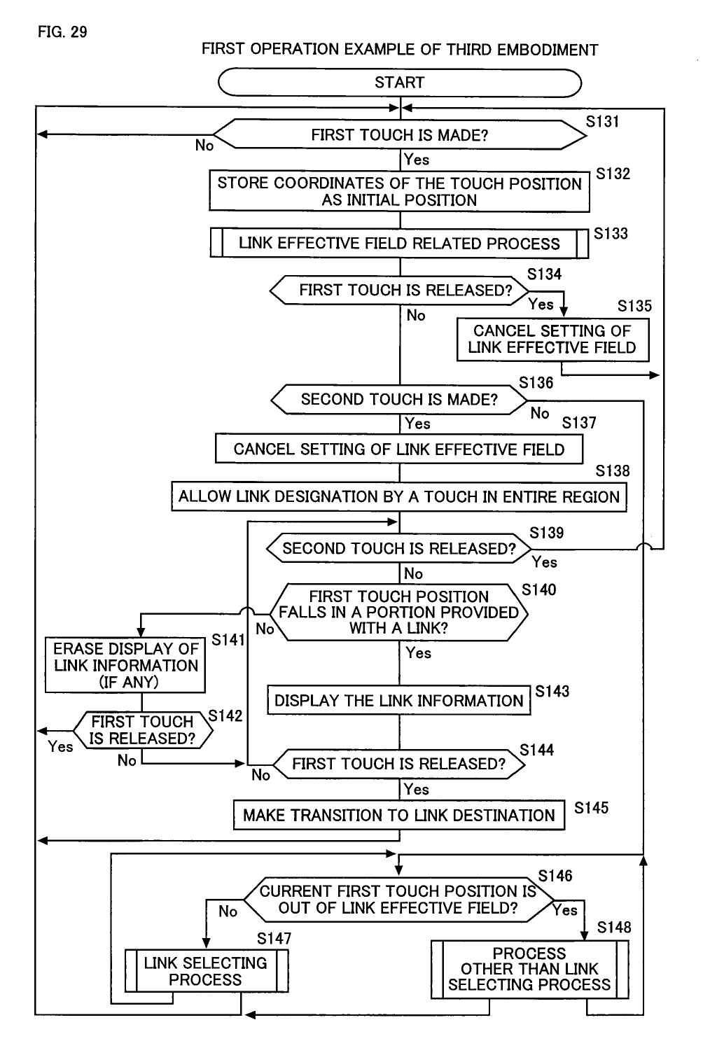

FIG. 29 is a flowchart showing the processing procedure of a first operation example according to the third embodiment.

Firstly, when there is a touch on the browser screen (S131, Yes), coordinates of the touch position are stored as an initial position (S132). Subsequently, the link effective field related processing unit 133 (FIG. 28) performs the link effective related processing (S133). A specific internal processing thereof will be described below.

If the first touch is released before the second touch is made (S134, Yes), setting of the link effective field is canceled (S135), and the processing returns to step S131.

When the second touch is made while keeping the first touch (S136, Yes), setting of the link effective field is canceled immediately (S135). On this occasion, the display of the link effective field is also erased. Therefore, the link designation which has been allowed only within the link effective field is now allowed in the overall region on the browser screen (S138). When the second touch is released, while the first touch is maintained (S139, Yes), the processing is returned to step S131.

In the state where the second touch is maintained, it is monitored whether or not the first touch position falls into the portion provided with a link (S140). A change of the touch position is checked constantly. If the touch position does not fall into the portion provided with a link (S140, No), the display of the link information (if any) is erased (S141), and if the first touch is not released (S142, No), the processing returns to step S139. If the first touch is released, the processing returns to step S131. On this occasion, the first touch having been the second touch so far is regarded as the first touch.

When the first touch position falls into the portion provided with a link in step S140, the link information of the link is displayed within the link information display field 340 (S143). In this state, if the first touch is released (S144, Yes), transition is made to the destination of the link (S145).

After moving to the link destination, the processing returns to step S131. On this occasion, the touch having been the second touch so far is regarded as the first touch.

If the second touch is not made in step S136, it is checked whether or not the current first touch position has gone out of the link effective field (S146). While the current first touch position is not out of the link effective field, the link selecting process is performed (S147). When the current first touch position is out of the link effective field, “a predetermined process” other than the link selecting process is performed (S148).

Since the link effective field related processes (1) and (2) corresponding to the above step S133 are the same as those shown in FIG. 14, a tedious explanation will not be made.

Since the link effective field related processes (3) and (4) corresponding to the above step S113 are the same as those shown in FIG. 15, a tedious explanation will not be made.

Since the link selecting process as shown in step S147 in FIG. 29 is the same as the process shown in FIG. 16, a tedious explanation will not be made. However, the “touch” in FIG. 16 is equivalent to the “first touch” in the present process.

Since the “predetermined process” in step S148 as described above is the same as the process shown in FIG. 17, a tedious explanation will not be made. However, the “touch” in FIG. 17 is equivalent to the “first touch” in the present process.

Since the scrolling process (2) as one example of the predetermined process of step S148 shown in FIG. 29 is the same as the process shown in FIG. 18, a tedious explanation will not be made. However, the “touch” in FIG. 18 is equivalent to the “first touch” in the present process.

Since the “menu selecting process” as an alternative example of the predetermined process of step S148 shown in FIG. 29 is the same as the process shown in FIG. 19, a tedious explanation will not be made. However, the “touch” in FIG. 19 is equivalent to the “first touch” in the present process.

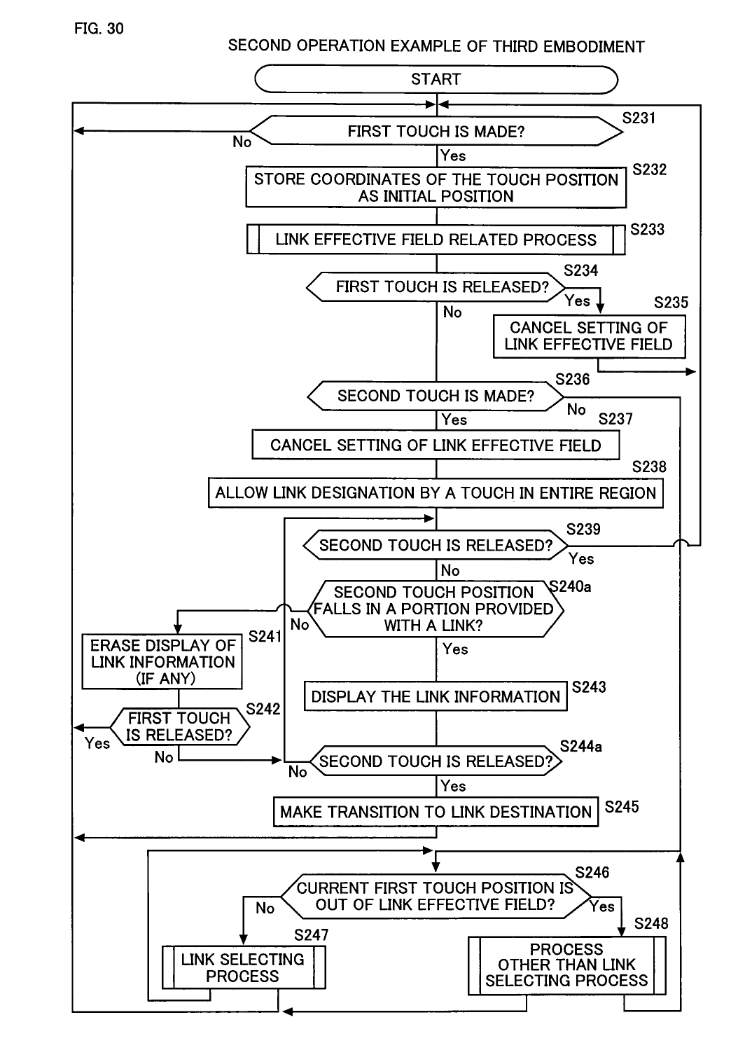

FIG. 30 is a flowchart showing a processing procedure of a second operation example according to the third embodiment of the present invention.

The process shown in FIG. 30 is different from the process shown in FIG. 29 in the points that steps S240 and S244 in FIG. 25 are respectively changed to steps S240a and S244a. In step S240a, it is checked whether or not the second touch position, not the first touch position, falls into the portion provided with a link. In step S244a, it is checked whether or not the second touch, not the first touch, has been released. Accordingly, in the process shown in FIG. 30, a link designation according to the second touch is accepted.

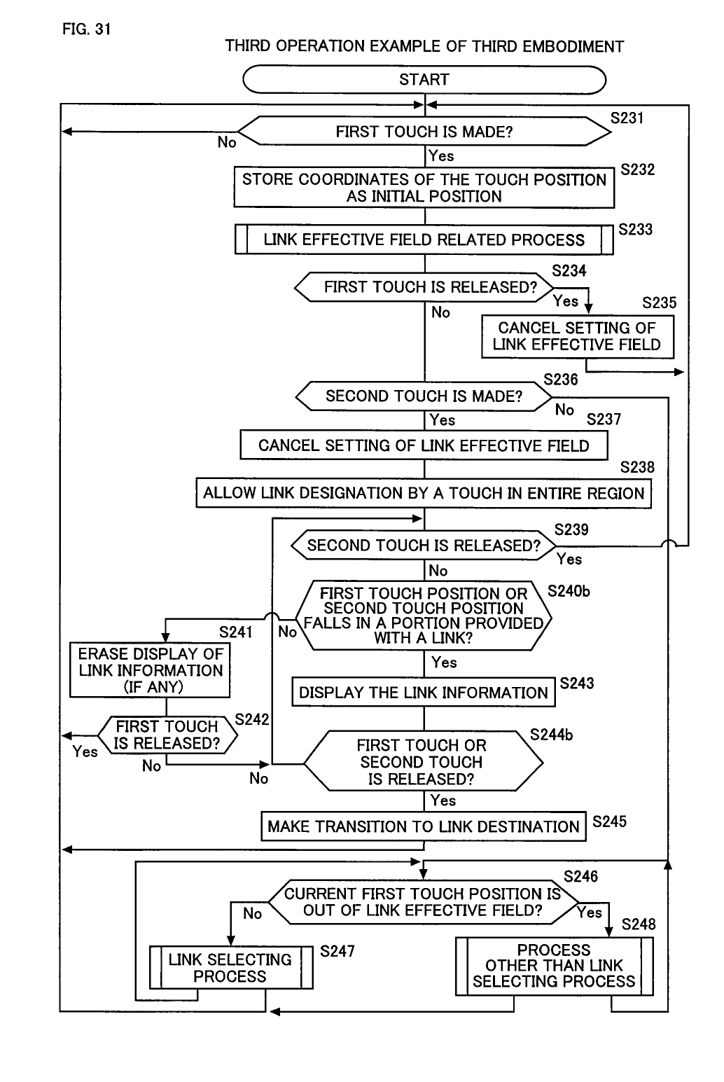

FIG. 31 is a flowchart showing a third operation example in the third embodiment. The steps which are the same as those shown in FIG. 29 are labeled the same, and tedious explanations will not be made. The process shown in FIG. 31 is different from the process shown in FIG. 29 in the points that steps S240 and S244 in FIG. 29 are respectively changed to steps S240b and S244b. In step S240b, it is checked whether or not either the first touch position or the second touch position, not the first touch position only, falls into the portion provided with a link. In step S244a, it is checked whether or not the touch in step S240b has been released. Accordingly, a link designation by any of the first touch and the second touch is accepted in the processing of FIG. 31.

While several embodiments are described in detail according to the present invention, it should be understood that disclosed embodiments are susceptible of changes and modifications without departing from the scope of the appended claims, in addition to the descriptions above.

By way of example, FIG. 1 illustrates a terminal apparatus which is not provided with a hardware keyboard, but a device which is provided with the hardware keyboard is also applicable. Even more particularly, the terminal apparatus is not limited to a phone terminal, but it may be any terminal apparatus with a display screen which is able to accept a touch input, and it is not necessarily a portable type. By way of example, the terminal may be a PC, a PDA, a game machine, a car navigation system, a household electrical appliance, an automatic vending machine, or the like.

The explanation above has been made for the case where a touch is made only by a finger. However, the present invention is also applicable to the case where two pens are used, or a pen is used with a finger.

In the first scrolling process, the scrolling speed is determined according to a length (distance) of the moving vector, but the scrolling speed may be kept constant without depending on the distance.

### INDUSTRIAL APPLICABILITY

The present invention maybe applicable in designing and/or manufacturing a terminal apparatus.

1. A terminal apparatus comprising,
a touch panel for detecting coordinates of a touch position,
a display unit where a touch field of the touch panel overlaps with at least a part of a display field thereof,
a storage unit for storing document in which a link is set, and
a controller, wherein,
the controller serves to interpret the document data and generate display information to be displayed on the display unit,
to set a predetermined range including a position being touched, as a link effective field,
to allow a link selection only within the link effective field,
to make transition to a link destination of the link having been in a touched state at the time of releasing of the touch within the link effective field, and
to perform a predetermined process other than the link selection, when the touch moves outwardly from inside the link effective field while keeping the touched state.

2. The terminal apparatus according to claim 1, wherein,
the controller displays the link effective field in such a manner that a user is allowed to identify the link effective field when a touch is made on the touch panel.

3. The terminal apparatus according to claim 1, wherein,
the controller allows the display unit to temporarily enlarge a display image of the document data under a predetermined condition, when a touch is made on the touch panel.

4. The terminal apparatus according to claim 1, wherein,
the controller allows the display unit to enlarge the link effective field under a predetermined condition.

5. The terminal apparatus according to claim 3, wherein,
the predetermined condition is determined according to either of the number of links belonging to the link effective field and an area of the touch.

6. The terminal apparatus according to claim 1, wherein,
the controller further serves to display link information of the link being touched within the link effective field, at a position other than a position being touched.

7. The terminal apparatus according to claim 2, wherein,
the controller disables the link effective field, if no links exist within the link effective field, when a touch is made on the touch panel.

8. The terminal apparatus according to claim 1, wherein,
the predetermined process other than the link selection is a process for changing a display mode of the document data.

9. The terminal apparatus according to claim 8, wherein,
the predetermined process other than the link selection is a process for scrolling the display image of the document data.

10. The terminal apparatus according to claim 9, wherein,
the scrolling process is to perform scrolling toward a position initially touched (hereinafter, referred to as an initial position), with respect to a position of a destination to which the touch has moved.

11. The terminal apparatus according to claim 10, wherein,
the scrolling process is to continue scrolling at a scrolling speed in accordance with a distance from the initial position to the position of the destination, until the touch is released.

12. The terminal apparatus according to claim 11, wherein,
the controller serves to erase the link effective field and displays a predetermined mark at the initial position, when the touch moves outwardly from inside the link effective field while keeping the touched state.

13. The terminal apparatus according to claim 9, wherein,
the scrolling process is to perform scrolling in sync with movement of the touch from the initial position to the position of the destination to which the touch has moved.

14. The terminal apparatus according to claim 1, wherein,
the predetermined process other than the link selection is a process for displaying menu items and selecting one from the menu items which are associated with displaying the document data.

15. The terminal apparatus according to claim 1, wherein,
the predetermined process other than the link selection is a process for switching the display screen.

16. A link selection method for selecting a link in a terminal apparatus for displaying as an image a document to which a link is placed, on a display screen which also serves as a touch panel, the link selection method comprising the steps of:
interpreting the document data and generating display information which is displayed on the display screen,
setting a predetermined range including a position being touched as a link effective field,
allowing a link selection only within the link effective field,
making transition to a destination of the link which has been in a touched state when the touch is released in the link effective field, and
executing a predetermined process other than the link selection, when the touch moves outwardly from inside the link effective field while keeping the touched state.

17. A display program executed in a controller of a terminal apparatus for displaying as an image a document to which a link is placed, on a display screen which also serves as a touch panel, the display program allowing a computer to execute the steps of:
interpreting the document data and generating display information which is displayed on the display screen,
setting a predetermined range including a position being touched as a link effective field,
allowing a link selection only within the link effective field,
making transition to a destination of the link which has been in a touched state when the touch is released in the link effective field, and
executing a predetermined process other than the link selection, when the touch moves outwardly from inside the link effective field while keeping the touched state.

18. A terminal apparatus comprising,
a touch panel for detecting coordinates of a position being touched,
a display unit where a touch field of the touch panel overlap one another within at least a part of the display field,
a storage unit for storing document data to which a link is placed, and
a controller, wherein,
the controller serves to interpret the document data and generate display information to be displayed on the display unit,
to make transition to a destination of the link which has been in a touched state when the touch is released in the link selecting process,
to perform a predetermined process based on a first touch, and
to disable the predetermined process, when a second touch is made while keeping the touched state of the first touch, and activates the link selecting process based on at least one of the first touch and the second touch, all over the display screen of the document data.

19. The terminal apparatus according to claim 18, wherein,
the predetermined process is a scrolling process for scrolling the display image of the document data according to movement of the first touch.

20. The terminal apparatus according to claim 18, wherein,
the predetermined process is a process for allowing a selection of link only within the link effective field which defines a predetermined range including a position being touched by the first touch.

21. The terminal apparatus according to claim 20, wherein,
the controller disables the link effective field, if no links exist within the link effective field when the touch is made on the touch panel.

22. The terminal apparatus according to claim 21, wherein,
the predetermined process includes a predetermined process other than the link selection, when the first touch moves outwardly from inside the link effective field while keeping the touched state.

23. The terminal apparatus according to claim 20, wherein,
the controller allows the display unit to display the link effective field in such a manner that a user identifies the link effective field.

24. The terminal apparatus according to claim 19, wherein,
the controller performs the scrolling process based on the first touch and disables the scrolling process based on the second touch, and at the same time, allowing the link selecting process to be performed based on the first touch whose touched state is maintained.

25. The terminal apparatus according to claim 19, wherein,
the controller performs the scrolling process based on the first touch and disables the scrolling process based on the second touch, and at the same time, allowing the link selecting process to be performed based on the second touch.

26. The terminal apparatus according to claim 18, wherein,
in the case where the link selecting process is activated, the controller further serves to display link information of the link at a location other than the touch position, when at least one of the first touch and the second touch designates a portion where the link is placed.

27. The terminal apparatus according to claim 22, wherein,
the predetermined process other than the link selection is a process for changing a display mode of the document data.

28. The terminal apparatus according to claim 27, wherein,
the predetermined process other than the link selection is a process for scrolling the display image of the document data.

29. The terminal apparatus according to claim 28, wherein,
the scrolling process is to perform scrolling toward a position initially touched (hereinafter, referred to as an initial position), with respect to a position of a destination to which the first touch has moved.

30. The terminal apparatus according to claim 28, wherein,
the scrolling process is to continue scrolling at a scrolling speed in accordance with a distance from the initial position to the position of the destination, until the first touch is released.

31. The terminal apparatus according to claim 30, wherein,
the controller serves to erase the link effective field and displays a predetermined mark at the initial position, when the first touch moves outwardly from inside the link effective field while keeping the touched state.

32. The terminal apparatus according to claim 28, wherein,
the scrolling process is to perform scrolling in sync with movement of the touch from the initial position to the position of the destination to which the touch has moved.

33. The terminal apparatus according to claim 22, wherein,
the predetermined process other than the link selection is a process for displaying menu items and selecting one from the menu items which are associated with displaying the document data.

34. The terminal apparatus according to claim 22, wherein,
the predetermined process other than the link selection is a process for switching the display screen.

35. A link selection method for selecting a link on a terminal apparatus which displays as an image a document being provided with a link, on a display screen also serving as a touch panel, comprising the steps of:
interpreting the document data and generating display information to be displayed on the display screen,
moving to a destination of the link which has been in a touched state when the touch is released in the link selecting process,
executing a predetermined process based on a first touch, and
disabling the predetermined process when a second touch is made in the state that the touched state of the first touch is maintained, and activating the link selecting process based on at least one of the first touch and the second touch all over the display screen of the document data.

36. The link selection method according to claim 35, further comprising the steps of:
setting a predetermined range including a position being touched by the first touch, as a link effective field,
allowing a selection of the link only within the link effective field, and
executing a predetermined process other than the selection of the link, when the first touch moves outwardly from inside the link effective field while keeping the touched state.

37. The link selection method according to claim 36, further comprising,
a step of disabling the link effective field if no links exist within the link effective field when the first touch is made on the touch panel.

38. A display program executed in the controller of the terminal apparatus for displaying as an image a document which is provided with a link, on a display screen also serving as a touch panel, the display program allowing a computer to perform the steps of:
interpreting document data and generating display information to be displayed on the display screen,
moving to a destination of the link which has been in a touched state when a touch is released in a link selecting process,
executing a predetermined process based on a first touch, and
disabling the predetermined process when a second touch is made while the touched state of the first touch is maintained, and activating the link selecting process based on at least one of the first touch and the second touch all over the display screen of the document data.

39. The display program according to claim 38, further allowing the computer to perform the steps of:
setting a predetermined range including a position being touched by the first touch, as a link effective field,
allowing a selection of the link only within the link effective field, and
executing a predetermined process other than selecting the link, when the first touch moves outwardly from inside the link effective field while keeping the touched state.

40. The display program according to claim 39, further allowing the computer to perform a step of disabling the link effective field, if no links exist within the link effective field when the first touch is made on the touch panel.
